(19) United States
(12) Patent Application Publication
(10) Pub. No.: US 2025/0293231 A1
(43) Pub. Date: Sep. 18, 2025

(54) METHOD FOR PRODUCING ELECTRODE AND ELECTRODE

(71) Applicants: Aya UTSUKI, Tokyo (JP); Kayato OHYA, Kanagawa (JP); Masako ICHINOSE, Kanagawa (JP); Toshiya SHIRAKURA, Kanagawa (JP); Toshiya SAGISAKA, Kanagawa (JP)

(72) Inventors: Aya UTSUKI, Tokyo (JP); Kayato OHYA, Kanagawa (JP); Masako ICHINOSE, Kanagawa (JP); Toshiya SHIRAKURA, Kanagawa (JP); Toshiya SAGISAKA, Kanagawa (JP)

(21) Appl. No.: 19/078,323

(22) Filed: Mar. 13, 2025

(30) Foreign Application Priority Data
Mar. 18, 2024 (JP) 2024-041918
Nov. 28, 2024 (JP) 2024-206863

(51) Int. Cl. H01M 4/04; H01G 11/26; H01G 11/86

(52) U.S. Cl. CPC H01M 4/0419; H01M 4/0404; H01M 4/043; H01G 11/26; H01G 11/86

(57) ABSTRACT

A method for producing an electrode is provided. The method includes applying an electrode mixture layer forming liquid composition including an active material and a dispersion medium onto a substrate at an application period of 0.28 mm or more and 1.7 mm or less, using a liquid ejection device having a plurality of nozzle holes arranged in parallel to a surface of the substrate, to form an electrode mixture layer having a periodic concave-convex structure on its surface.

### CROSS-REFERENCE TO RELATED APPLICATIONS

This patent application is based on and claims priority pursuant to 35 U.S.C. § 119(a) to Japanese Patent Application Nos. 2024-041918 and 2024-206863, filed on Mar. 18, 2024 and Nov. 28, 2024, in the Japan Patent Office, the entire disclosure of each of which is hereby incorporated by reference herein.

### BACKGROUND

### Technical Field

The present disclosure relates to a method for producing an electrode, and an electrode.

### Related Art

In recent years, a range of applications of electrochemical elements such as a lithium ion secondary battery, an electric double layer capacitor, a lithium ion capacitor, and a redox capacitor has expanded rapidly from small consumer devices such as a wearable device and a smartphone to large devices such as an electric vehicle and a stationary storage battery.

In response to such diversifying needs of the electrochemical elements, an electrode having a sparse-dense structure has been proposed to improve battery characteristics.

### SUMMARY

According to embodiments of the present invention, a method for producing an electrode is provided. The method includes applying an electrode mixture layer forming liquid composition including an active material and a dispersion medium onto a substrate at an application period of 0.28 mm or more and 1.7 mm or less, using a liquid ejection device having a plurality of nozzle holes arranged in parallel to a surface of the substrate, to form an electrode mixture layer having a periodic concave-convex structure on its surface.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram for describing an electrode concave-convex period of according to an embodiment of the present invention;

FIGS. 2A to 2D are schematic diagrams for describing structures of a liquid ejection device according to embodiments of the present invention;

FIG. 3 is a schematic diagram illustrating a liquid ejection device according to an embodiment of the present invention;

FIG. 4A is a schematic cross-sectional diagram illustrating an electrode obtained by a method for producing an electrode according to an embodiment of the present invention;

FIG. 4B is a schematic cross-sectional diagram for describing a mechanism by which an electrode concave-convex periodic structure is formed in an electrode obtained by a method for producing an electrode according to an embodiment of the present invention;

FIG. 5A is a schematic cross-sectional diagram illustrating an electrode obtained by a method for producing an electrode according to an embodiment of the present invention;

FIG. 5B is a schematic cross-sectional diagram illustrating an electrode obtained by a method for producing an electrode according to an embodiment of the present invention;

FIG. 6 is a schematic diagram illustrating an electrode production apparatus according to an embodiment of the present invention;

FIG. 7 is a schematic diagram illustrating an electrode production apparatus according to an embodiment of the present invention;

FIG. 8 is a schematic diagram illustrating an electrode production apparatus according to an embodiment of the present invention;

FIG. 9 is a schematic diagram illustrating a modification of an electrode production apparatus according to an embodiment of the present invention;

FIG. 10 is a configuration diagram illustrating a printing device including an electrode mixture layer forming liquid composition application device employing an inkjet method and a transfer method, in an electrode production apparatus according to an embodiment of the present invention;

FIG. 11 is a configuration diagram illustrating a printing device including an electrode mixture layer forming liquid composition application device employing the inkjet method and the transfer method, in an electrode production apparatus according to an embodiment of the present invention;

FIG. 12 is a schematic diagram illustrating a formation pattern of an electrode mixture layer in a method for producing an electrode according to an embodiment of the present invention;

FIG. 13 is a schematic diagram illustrating a formation pattern of an electrode mixture layer in a method for producing an electrode according to an embodiment of the present invention;

FIG. 14 is a schematic cross-sectional diagram illustrating an electrochemical element according to an embodiment of the present invention;

FIG. 15 is a schematic cross-sectional diagram illustrating an electrochemical element according to an embodiment of the present invention; and

FIG. 16 is a schematic diagram illustrating a moving body as an electrochemical element according to an embodiment of the present invention.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to embodiments of the present invention, a method for producing an electrode having an excellent rate characteristic is provided.

A method for producing an electrode according to an embodiment of the present invention is a method for producing an electrode including an electrode mixture layer having a periodic concave-convex structure on its surface. The method for producing an electrode includes an electrode mixture layer forming liquid composition application step of applying an electrode mixture layer forming liquid composition including an active material and a dispersion medium onto a substrate at an application period of 0.28 mm and more and 1.7 mm or less using a liquid ejection device including a plurality of nozzle holes arranged in a direction parallel to a surface of the substrate.

Such a configuration can provide a method for producing an electrode having an excellent rate characteristic.

Details of embodiments of the present invention are described below.

### Method for Producing an Electrode and Electrode Production Apparatus

The method for producing an electrode according to an embodiment of the present invention is a method for producing an electrode including an electrode mixture layer having a periodic concave-convex structure on its surface. The method for producing an electrode includes an electrode mixture layer forming liquid composition application step and may include an electrode mixture layer forming liquid composition drying step and other steps as necessary.

The electrode production apparatus according to an embodiment of the present invention is an apparatus for producing an electrode including an electrode mixture layer having a periodic concave-convex structure on its surface. The electrode production apparatus includes an electrode mixture layer forming liquid composition application device and may include an electrode mixture layer forming liquid composition drying device and other devices as necessary.

The method for producing an electrode can be suitably performed by the electrode production apparatus, the electrode mixture layer forming liquid composition application step can be suitably performed by the electrode mixture layer forming liquid composition application device, the electrode mixture layer forming liquid composition drying step can be suitably performed by the electrode mixture layer forming liquid composition drying device, and the other steps can be suitably performed by the other devices.

The electrode produced by the method for producing an electrode according to an embodiment of the present invention includes a substrate and an electrode mixture layer, on the substrate, having a periodic concave-convex structure on its surface. A ratio (h1/h2) of a height h1 (μm) of a concave portion of the electrode mixture layer relative to a height h2 (μm) of a convex portion of the electrode mixture layer is 0.71 or more and 0.95 or less. By having the periodic concave-convex structure on the surface of the electrode mixture layer, the surface area increases, and electrolyte permeability improves compared to a flat electrode mixture layer, thereby obtaining an excellent rate characteristic.

In the present specification, the height of the convex portion based on the bottom of the electrode mixture layer is defined as h2, and the height of the concave portion is defined as h1. However, when a pressing step is performed for forming the electrode mixture layer, a range of the ratio (h1/h2) indicates a range of the ratio (h1/h2) before the pressing step.

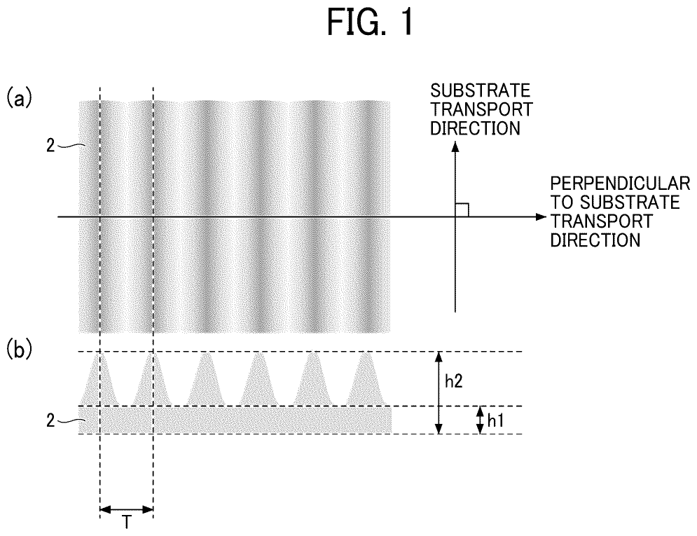

In the present specification, the term “periodic concave-convex structure” refers to a structure in which concave and convex portions are arranged alternately and periodically, as presented in FIG. 1. Note that the period in the electrode (electrode mixture layer) is referred to as “electrode concave-convex period” to avoid confusion with the application period, and the structure may be referred to as “electrode concave-convex periodic structure”. Note that FIG. 1(a) is a schematic diagram illustrating an electrode mixture layer 2 as viewed from above, and FIG. 1(b) is a schematic cross-sectional diagram illustrating the electrode mixture layer 2 as viewed from the side.

In the present specification, the electrode concave-convex period corresponds to a distance from apex to apex of adjacent convex portions in a direction perpendicular to a substrate transport direction. The electrode concave-convex period is defined by a value obtained by dividing a distance (Tn) across n consecutive adjacent convex portions by the number of intervals n-1.

The electrode concave-convex period can be controlled, for example, by changing the ejection nozzle interval or the ejection interval of the liquid ejection device, or the transport time of workpiece in the electrode mixture layer forming liquid composition application step described below.

Further, the electrode concave-convex periodic structure is controlled by the ejection frequency and the transport speed in the substrate transport direction. The period becomes shorter as the ejection frequency is higher or the transport speed is slower, while the period becomes longer as the ejection frequency is lower or the transport speed is faster. In the direction perpendicular to the substrate transport direction, the electrode concave-convex periodic structure is controlled by a distance between midpoints of the nozzles that eject droplets.

A method for measuring the electrode concave-convex period is not particularly limited and can be selected appropriately depending on the purpose. One example is presented below.

Observation is performed using a laser microscope VK-X3000 (manufactured by Keyence Corp.) equipped with a white light interferometer to obtain a cross-sectional concave-convex profile, thereby measuring the average period.

### Electrode Mixture Layer Forming Liquid Composition Application Step and Electrode Mixture Layer Forming Liquid Composition Application Device

The electrode mixture layer forming liquid composition application step is a step of applying an electrode mixture layer forming liquid composition including an active material and a dispersion medium onto a substrate at an application period of 0.28 mm or more and 1.7 mm or less using a liquid ejection device.

The electrode mixture layer forming liquid composition application device is a device for applying an electrode mixture layer forming liquid composition including an active material and a dispersion medium onto a substrate at an application period of 0.28 mm or more and 1.7 mm or less. In other words, this device is a liquid ejection device.

The application period in the present specification refers to a period set by the nozzle interval, the ejection interval, and the like when the electrode mixture layer is formed, and does not necessarily match the electrode concave-convex period formed thereby.

The application period is 0.28 mm or more, preferably 0.40 mm or more, from the viewpoint of the infusion effect on the electrode layer due to the improvement of the film surface area caused by the formation of the electrode concave-convex periodic structure, that is, from the viewpoint of the improvement of the rate characteristic.

The application period is 1.7 mm or less, preferably 1.3 mm or less, from the viewpoint of the infusion effect on the electrode layer due to the improvement of the film surface area caused by the formation of the electrode concave-convex periodic structure, that is, from the viewpoint of the improvement of the rate characteristic. If the application period exceeds 1.7 mm, it may be difficult to sufficiently form the electrode concave-convex periodic structure by coalescence of droplets or liquid columns.

### Electrode Mixture Layer Forming Liquid Composition Application Device (Liquid Ejection Device)

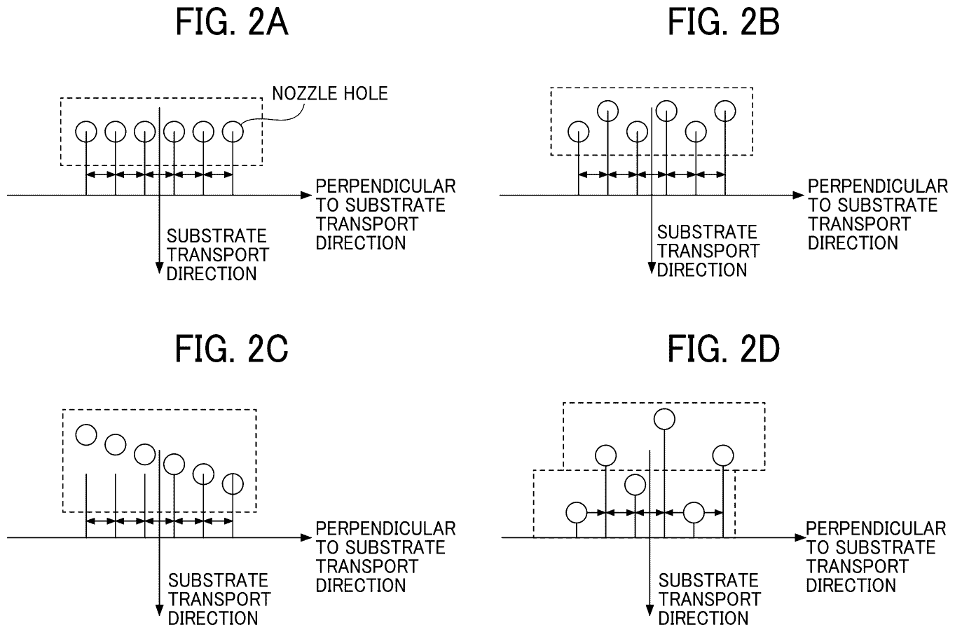

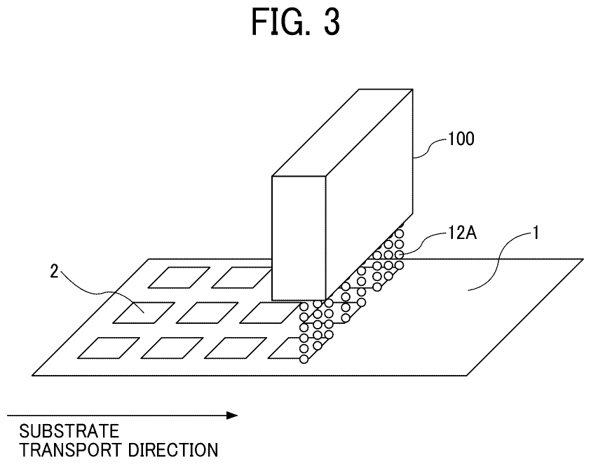

The liquid ejection device includes an ejection head including a plurality of nozzle holes arranged in a direction parallel to the substrate surface. In other words, the liquid ejection device includes an ejection head including a plurality of nozzles at equal intervals when the nozzles are projected onto an imaginary axis perpendicular to the transport direction of the substrate, as presented in FIGS. 2A to 2D. The liquid ejection device may include a plurality of the ejection heads. Further, the liquid ejection device may include other members, such as a printing device 100, as necessary (see FIG. 3). Note that FIGS. 2A to 2D are schematic diagrams illustrating a nozzle formation surface of the ejection head.

The electrode mixture layer forming liquid composition application device (liquid ejection device) is not particularly limited and can be appropriately selected depending on the purpose. Examples thereof include, but are not limited to, those employing an inkjet method. The inkjet method can be preferably used because it can perform printing on the substrate in a non-contact manner and in any shape depending on the purpose.

Examples of the ejection head used in the inkjet method include, but are not limited to, a piezoelectric head type, a thermal head type, and a valve head type. Of these, the valve head type is preferable from the viewpoint of having a large ejection hole diameter and being excellent for ejecting an active material with a relatively large particle diameter and a high viscosity liquid composition such as a high solid content liquid composition or a non-spherical composition such as a carbon nanotube or a carbon nanofiber.

The nozzle diameter is not particularly limited and can be appropriately selected depending on the purpose. However, from the viewpoint of preventing liquid dripping from the nozzle and forming a good image, the nozzle diameter is preferably 70 μm or more, and from the viewpoint of preventing clogging of a single particle or an aggregate of the positive electrode active material, the negative electrode active material, or the like and improving ejection stability, the nozzle diameter is more preferably 100 μm or more, even more preferably 150 μm or more.

### Substrate

The substrate in the present disclosure is not particularly limited and can be appropriately selected depending on the purpose, as long as it has electronic conductivity and is stable to the applied potential. Examples of the substrate include, but are not limited to, an aluminum foil, a copper foil, a stainless steel foil, a titanium foil, etched foils obtained by etching these foils to form fine holes, a carbon-coated foil whose surface is coated with a carbon-containing resin layer, a foil coated with a phase-transfer catalyst (PTC) layer, and a perforated substrate used in a lithium ion capacitor.

In the present specification, the substrate used in the negative electrode is referred to as “negative electrode substrate” or “substrate for negative electrode”, and the substrate used in the positive electrode is referred to as “positive electrode substrate” or “substrate for positive electrode”.

### Electrode Mixture Layer Forming Liquid Composition

The electrode mixture layer forming liquid composition includes an active material and a dispersion medium, and may include a binder, a dispersant, a conductive assistant, a solid electrolyte, and other components, as necessary.

### Active Material

As the active material, a positive electrode active material or a negative electrode active material can be used. Note that the positive electrode active material or the negative electrode active material may be used alone or in combination of two or more types.

### Positive Electrode Active Material

The positive electrode active material is not particularly limited and can be appropriately selected depending on the purpose, as long as it is a material that can reversibly absorb and release an alkali metal ion. Examples thereof include, but are not limited to, an alkali metal-containing transition metal compound.

Examples of the alkali metal-containing transition metal compound include, but are not limited to, a lithium-containing transition metal compound such as a composite oxide containing lithium and one or more elements selected from the group consisting of cobalt, manganese, nickel, chromium, iron, and vanadium.

Examples of the lithium-containing transition metal compound include, but are not limited to, lithium cobalt oxide, lithium nickel oxide, and lithium manganese oxide.

It is preferable that at least a part of the surface of the alkali metal containing transition metal compound is covered with an ion-conductive oxide. The ion-conductive oxide is preferably a lithium ion-conductive oxide.

The lithium ion-conductive oxide is not particularly limited and can be appropriately selected depending on the purpose. Examples thereof include, but are not limited to, an oxide represented by the general formula LiₓAO_{y} (A is B, C, Al, Si, P, S, Ti, Zr, Nb, Mo, Ta, Sc, V, Y, Ca, Sr, Ba, Hf, Ta, Cr, or W, and x and y are positive numbers).

Specific examples of the lithium ion-conductive oxide include, but are not limited to, Li₃BO₃, LiBO₂, Li₂CO₃, LiAlO₂, Li₄SiO₄, Li₃SiO₃, Li₃PO₄, Li₂SO₄, Li₂TiO₃, Li₄Ti₅O₁₂, Li₂Ti₂O₅, Li₂ZrO₃, LiNbO₃, LiTaO₃, Li₂MoO₄, and Li₂WO₄. Of these, Li₄Ti₅O₁₂, Li₂ZrO₃, or LiNbO₃ is preferable.

Further, the lithium ion-conductive oxide may be a composite oxide. The composite oxide may be any combination of lithium ion-conductive oxides, such as Li₄SiO₄—Li₃BO₃ and Li₄SiO₄—Li₃PO₄.

### Negative Electrode Active Material

The negative electrode active material is not particularly limited can be appropriately selected depending on the purpose, as long as it is a material that can reversibly absorb and release an alkali metal ion. Examples thereof include, but are not limited to, a carbon material containing graphite having a graphite crystal structure.

Examples of the carbon material include, but are not limited to, natural graphite, spherical or fibrous artificial graphite, non-graphitizable carbon (hard carbon), and easily graphitizable carbon (soft carbon).

Examples of the material other than carbon material include, but are not limited to, lithium titanate and titanium oxide.

From the viewpoint of increasing the energy density of a lithium ion secondary battery, a high capacity material such as silicon, tin, a silicon alloy, a tin alloy, silicon oxide, silicon nitride, or tin oxide can also be suitably used as the negative electrode active material. The particle size of the active material is not particularly limited and can be appropriately selected depending on the purpose. However, the particle size is preferably 0.5 μm or more and 20 μm or less, more preferably 3 μm or more and 10 μm or less.

When the particle size of the active material is 0.5 μm or more and 20 μm or less, ejection defects are unlikely to occur when the electrode mixture layer forming liquid composition is ejected by the liquid ejection device. Further, when the particle size of the active material is 3 μm or more and 10 μm or less, the electrode having better battery characteristics can be obtained.

Note that, in the present specification, the particle size is calculated as the diameter at the maximum value of the particle size distribution of the active material in the electrode mixture layer forming liquid composition.

A method for measuring the particle size of the active material is not particularly limited and can be appropriately selected depending on the purpose. For example, it can be measured in accordance with ISO 13320:2009.

A device used for the measurement is not particularly limited and can be appropriately selected depending on the purpose. Examples of the device include, but are not limited to, a laser diffraction particle size distribution analyzer.

### Binder

The binder is not particularly limited and can be appropriately selected depending on the purpose, as long as it is capable of binding the active materials together, and the active material and the substrate. Examples of the binder include, but are not limited to, a polymer compound.

The polymer compound is not particularly limited and can be appropriately selected depending on the purpose. Examples of the polymer compound include, but are not limited to, polyvinylidene fluoride (PVDF), an acrylic resin, polyethylene, polypropylene, polyurethane, nylon, polytetrafluoroethylene, polyphenylene sulfide, polyethylene terephthalate, polybutylene terephthalate, a polyamide compound, a polyimide compound, polyamide imide, ethylene-propylene-butadiene rubber (EPBR), styrene-butadiene rubber (SBR), nitrile butadiene rubber (NBR), isoprene rubber, polyisobutene, polyethylene glycol (PEO), poly(methyl methacrylate) (PMMA), poly(ethyl methacrylate) (PEMA), poly(butyl methacrylate) (PBMA), poly(ethylene vinyl acetate) (PEVA), poly[2-(dimethylamino)ethyl methacrylate], poly[2-(diethylamino)ethyl methacrylate], a poly[2-(dimethylamino)ethyl methacrylate]-poly(butyl methacrylate) copolymer, a poly[2-(diethylamino)ethyl methacrylate]-poly(butyl methacrylate) copolymer, and carboxymethyl cellulose.

The binder may be dissolved in the electrode mixture layer forming liquid composition or may be dispersed therein as particles. That is, the electrode mixture layer forming liquid composition may be in a form of an emulsion.

The content of the binder is not particularly limited and can be appropriately set depending on the purpose. However, from the viewpoint of improving the film strength of the active material, the content is preferably 0.5% by mass or more relative to the total amount of the active material, and from the viewpoint of preventing the deterioration of the battery characteristics due to the decrease in the coverage rate of the active material surface, the content is preferably 15% by mass or less relative to the total amount of the active material. Further, the content of the binder is more preferably 1% by mass or more and 10% by mass or less relative to the total amount of the active material, even more preferably 1.5% by mass or more and 5% by mass or less.

### Dispersion Medium

The dispersion medium is not particularly limited and can be appropriately selected depending on the purpose. Examples of the dispersion medium include, but are not limited to, water, a ketone-based dispersion medium such as N-methyl-2-pyrrolidone, 2-pyrrolidone, N,N-dimethylacetamide, or cyclohexanone, an ester-based dispersion mediums such as butyl acetate, an aromatic dispersion medium such as p-cymene, xylene, or mesitylene, an alcohol-based dispersion medium such as 2-n-butoxymethanol, 2-dimethylethanol, ethylene glycol, or propylene glycol, and an olefin-based solvent such as tetradecane or dodecane.

These may be used alone or in combination of two or more types.

When a sulfide solid electrolyte is included as other components, a low polarity solvent that does not include a hydroxyl group, a carboxyl group, and the like is preferably used to prevent the decomposition reaction of the sulfide solid electrolyte. Of these, an ester-based compound is preferable from the viewpoint of improving dispersibility.

### Dispersant

The dispersant is not particularly limited and can be appropriately selected depending on the purpose, as long as it is capable of improving the dispersibility of the active material and other particulate materials in the electrode mixture layer forming liquid composition. Examples of the dispersant include, but are not limited to: a polymeric dispersant such as carboxymethyl cellulose, a polyethylene-based dispersant, a polyethylene oxide-based dispersant, a polypropylene oxide-based dispersant, a polycarboxylic acid-based dispersant, a naphthalene sulfonic acid-formalin condensation-based dispersant, a polyethylene glycol-based dispersant, a polycarboxylic acid partial alkyl ester-based dispersant, a polyether-based dispersant, or a polyalkylene polyamine-based dispersant; a low molecular weight dispersant such as an alkylsulfonic acid-based dispersant, a quaternary ammonium-based dispersant, a higher alcohol alkylene oxide-based dispersant, a polyhydric alcohol ester-based dispersant, or an alkyl polyamine-based dispersant; and an inorganic dispersant such as a polyphosphate dispersant.

### Conductive Assistant

The conductive assistant is not particularly limited and can be appropriately selected depending on the purpose. Examples of the conductive assistant include, but are not limited to, a carbon material such as carbon black produced by a furnace method, an acetylene method, a gasification method, or the like, a carbon nanofiber, a carbon nanotube, graphene, or a graphite particle.

Examples of the conductive assistant other than the carbon material that can be used include, but are not limited to, a metal particle and a metal fiber made of aluminum or the like. Note that the conductive assistant may be compounded with the active material in advance.

The content of the conductive assistant relative to the active material is not particularly limited and can be appropriately set depending on the purpose. However, the content is preferably 10% by mass or less, more preferably 8% by mass or less. Further, the content is preferably 1% by mass or more.

When the content of the conductive assistant relative to the active material is 10% by mass or less, the stability of the electrode mixture layer forming liquid composition is improved, which is preferable. When the content of the conductive assistant relative to the active material is 8% by mass or less, the stability of the electrode mixture layer forming liquid composition is further improved, which is preferable.

When the content of the conductive assistant relative to the active material is 1% by mass or more, the effect of improving the conductivity of the electrode mixture layer is exhibited, which is preferable.

### Solid Electrolyte

The solid electrolyte is not particularly limited and can be appropriately selected depending on the purpose, as long as it exhibits electronic insulation and ion conductivity and does not react with the dispersion medium. Examples of the solid electrolyte include, but are not limited to, an oxide solid electrolyte and a sulfide solid electrolyte. Of these, a sulfide solid electrolyte is preferable from the viewpoint that the high plasticity allows good interfaces to be formed between the solid electrolyte particles or between the solid electrolyte and the active material, and a crystalline argyrodite-type sulfide solid electrolyte is more preferable from the viewpoint of obtaining an excellent dispersion effect similar to that of the active material.

Examples of the oxide solid electrolyte include, but are not limited to, a compound that contains an oxygen atom, has ionic conductivity of a metal belonging to group 1 or 2 of the periodic table, and has electronic insulation properties.

Note that, in the present specification, the phrase “having electronic insulation properties” refers to a state in which a short circuit does not occur when a positive electrode and a negative electrode are placed to face each other with a solid electrolyte layer interposed therebetween.

Note that, in the present specification, the phrase “exhibiting ionic conductivity” means that when a positive electrode and a negative electrode are placed to face each other with a solid electrolyte layer interposed therebetween, application of a potential difference causes only ions to move.

Specific examples of the oxide solid electrolyte include, but are not limited to, LiₓₐLa_{ya}TiO₃ [xa=0.3 to 0.7, ya=0.3 to 0.7] (LLT), Li_{xb}L_{ay}Zr_{zb}Mbb_{mb}O_{nb} (Mbb is at least one element selected from Al, Mg, Ca, Sr, V, Nb, Ta, Ti, Ge, In, and Sn, and xb satisfies 5≤xb≤10, yb satisfies 1≤yb≤4, zb satisfies 1≤zb≤4, mb satisfies 0≤mb≤2, and nb satisfies 5≤nb≤20), Li_{xc}B_{yc}Mcc_{zc}O_{nc} (Mcc is at least one element selected from C, S, Al, Si, Ga, Ge, In, and Sn, and xc satisfies 0≤xc≤5, yc satisfies 0≤yc≤1, zc satisfies 0≤zc≤1, and nc satisfies 0≤nc≤6), Li_{xd}(Al,Ga)_{yd}(Ti,Ge)_{zd}Si_{ad}P_{md}O_{nd} (where 1≤xd≤3, 0≤yd≤1, 0≤zd≤2, 0≤ad≤1, 1≤md≤7, and 3≤nd≤13), Li₍₃₋₂ₓₑ₎ MeeₓₑDeeO (xe is a number of 0 and more and 0.1 or less, Mee is a divalent metal atom, and Dee is a halogen atom or a combination of two or more halogen atoms), Li_{xf}Si_{yf}O_{zf} (1≤xf≤5, 0<yf≤3, and 1<zf≤10), Li_{xg}S_{yg}O_{zg} (1≤xg≤3, 0<yg≤2, 1<zg≤10), Li₃BO₃—Li₂SO₄, Li₂O—B₂O₃—P₂O₅, Li₂O—SiO₂, Li₆BaLa₂Ta₂O₁₂, Li₃PO_{(4-3/2w)}N_{w} (w<1), Li_{3.5}Zn_{0.25}GeO₄ with lithium super ionic conductor (LISICON) type crystal structure, La_{0.55}Li_{0.35}TiO₃ with perovskite type crystal structure, LiTi₂P₃O₁₂ with sodium super ionic conductor (NASICON) type crystal structure, Li_{1+xh+yh}(Al,Ga)ₓₕ(Ti,Ge)₂₋ₓₕSi_{yh}P_{3-yh}O₁₂ (where 0≤xh≤1, 0≤yh≤1), and Li₇La₃Zr₂O₁₂ (LLZ) with garnet type crystal structure.

As the oxide solid electrolyte, a phosphorus compound containing Li, P, and O is also preferable. Examples thereof include, but are not limited to, lithium phosphate (Li₃PO₄), LiPON in which some of oxygen atoms in lithium phosphate is replaced with nitrogen, and LiPOD1 (D1 is at least one selected from Ti, V, Cr, Mn, Fe, Co, Ni, Cu, Zr, Nb, Mo, Ru, Ag, Ta, W, Pt, Au, and the like).

LiA¹ON (A¹ is at least one selected from Si, B, Ge, Al, C, Ga, and the like) and the like can also be preferably used.

The sulfide solid electrolytes can be roughly divided into, for example, crystalline sulfide solid electrolytes and glass-based sulfide solid electrolytes.

Examples of the crystalline sulfide solid electrolytes include, but are not limited to, Li_{9.54}Si_{1.74}P_{1.44}S_{11.7}Cl_{0.3}, Li_{9.6}P₃S₁₂, Li₉P₃S₉O₃, Li_{9.81}Sn_{0.81}P_{2.19}S₁₂, Li_{9.42}Si_{1.02}P_{2.1}S_{9.96}O_{2.04}, Li₁₀Ge(P₁₋ₓSbₓ)₂S₁₂ (0≤x<0.15), Li₁₀SnP₂S₁₂, Li_{10.35} [M1₁₋ₓM2ₓ]_{1.35}P_{1.65}S₁₂ (M1 and M2 each represent one of Si, Ge, Sn, As, and Sb, 0≤x≤0.15), Li₁₁Si₂PS₁₂, Li₁₁AlP₂S₁₂, Li_{3.45}Si_{0.45}P_{0.55}S₄, Li₆PS₅X (X represents Cl, Br, or I), Li₅PS₄X₂ (X represents Cl, Br, or I), Li_{5.5}PS_{4.5}Cl_{1.5}, Li_{5.35}Ca_{0.1}PS_{4.5}Cl_{1.55}, Li₆₊ₓMₓSb₁₋ₓS₅I (M represents Si, Ge, or Sn, 0≤x≤1), Li₇P₂S₈I, γ-Li₃PS₄, Li₄MS₄ (M represents Ge, Sn, or As), Li₄₋ₓSn₁₋ₓSbₓS₄ (0≤x≤0.15), Li₄₋ₓGe₁₋ₓPₓS₄ (0≤x≤0.15), and Li₃₊₅ₓP₁₋ₓS₄ (0≤x≤0.3).

Examples of the glass-based sulfide solid electrolytes include, but are not limited to, Li₂S—P₂S₅, Li₂S—P₂S₅—LiI, Li₂S—P₂S₅—P₂O₅, Li₂S—P₂S₅—LiCl, Li₂S—SiS₂, Li₂S—SiS₂—P₂S₅, Li₂S—SiS₂—Al₂S₃, and Li₂S—SiS₂—LiₓMO_{y} (M represents Si, P, or Ge).

Also, Li₇P₃S₁₁ glass ceramics in which a part of the glass-based sulfide solid electrolyte is crystallized, or the like can be used. The mixing ratio of each raw material of the glass-based sulfide solid electrolyte can be freely determined.

### Other Components

The other components are not particularly limited and can be appropriately selected depending on the purpose. Examples of the other components include, but are not limited to, a dispersant, a solid electrolyte, a dispersion medium, a surfactant, a pH adjuster, a rust inhibitor, a preservative, an antifungal agent, an antioxidant, a reduction inhibitor, an evaporation promoter, a chelating agent, a thickener, and an ionic liquid.

### Viscosity

The viscosity of the electrode mixture layer forming liquid composition is preferably 20 mPa·s or more, more preferably 40 mPa·s or more, from the viewpoint of preventing flattening (i.e., reduction in h1/h2) due to the weight of the electrode mixture layer forming liquid composition itself landing on the substrate. Note that, in the present specification, the term “flattening” refers to a state in which applied droplets of the electrode mixture layer forming liquid composition are coalesced with adjacent droplets to form a film with a uniform thickness.

The viscosity of the electrode mixture layer forming liquid composition is preferably 150 mPa·s or less, more preferably 100 mPa·s or less, even more preferably 70 mPa·s or less, from the viewpoints of preventing a film interface caused by coalescence of droplets or liquid columns formed by the electrode mixture layer forming liquid composition and improving film strength.

A method for measuring the viscosity of the electrode mixture layer forming liquid composition is not particularly limited and can be appropriately selected depending on the purpose. For example, the viscosity can be measured according to JIS Z 8803. A device used for the measurement is not particularly limited and can be appropriately selected depending on the purpose. Examples of the device include, but are not limited to, a Model TV25 viscometer (a cone-plate type viscometer, manufactured by Tokisangyo).

Note that the viscosity of the electrode mixture layer forming liquid composition is measured under conditions of a temperature of 25° C. and a rotation speed of 50 rpm.

### Solid Content Concentration

The solid content concentration of the electrode mixture layer forming liquid composition is not particularly limited and can be appropriately selected depending on the purpose. However, it is preferably 40% by mass or more, more preferably 50% by mass or more, even more preferably 60% by mass or more.

When the solid content concentration of the electrode mixture layer forming liquid composition is 40% by mass or more, the thixotropy is easily exhibited, resulting in good dispersion stability, and the flow is prevented during the step of drying the applied electrode mixture layer forming liquid composition, thereby preventing unevenness in film thickness and composition due to drying. Further, the required drying time is shortened, resulting in improved productivity, reduced environmental impact, and associated cost reduction effects.

In the present specification, the term “solid content concentration of the electrode mixture layer forming liquid composition” refers to a mass percentage of the mass of components contained therein excluding the dispersion medium and water, relative to the total mass of the electrode mixture layer forming liquid composition.

A method for measuring the solid content concentration of the electrode mixture layer forming liquid composition is not particularly limited and can be appropriately selected depending on the purpose. For example, in a case where the composition of the electrode mixture layer forming liquid composition is known, a method of determining the solid content concentration based on the following formula, or the like can be mentioned. In a case where the composition of the electrode mixture layer forming liquid composition is not known, a method of measuring the solid content concentration according to JIS K 5601-1-2, or the like can be mentioned.

$$Solid content concentration = [ total solid content ( parts by mass ) / ( total solid content ( parts by mass ) + dispersion medium ( parts by mass ) + water ( parts by mass ) ) ] \times 100 ( \% ) \qquad Formula$$

A device used to measure the solid content concentration of the electrode mixture layer forming liquid composition is not particularly limited and can be appropriately selected depending on the purpose. Example of the device include, but are not limited to, a heat-dry type solid content meter (MX-50, manufactured by A&D Company, Ltd.).

### Production Method of Electrode Mixture Layer Forming Liquid Composition

The electrode mixture layer forming liquid composition can be produced by dissolving or dispersing each component in the dispersion medium. Specifically, the electrode mixture layer forming liquid composition can be produced by mixing each component and the dispersion medium using a mixer such as a ball mill, a sand mill, a bead mill, a pigment disperser, a crusher, an ultrasonic disperser, a homogenizer, a planetary mixer, or FILMIX.

### Electrode Mixture Layer Forming Liquid Composition Drying Step and Electrode Mixture Layer Forming Liquid Composition Drying Device

The electrode mixture layer forming liquid composition drying step is a step of drying the applied electrode mixture layer forming liquid composition.

The electrode mixture layer forming liquid composition drying device is a device for drying the applied electrode mixture layer forming liquid composition.

The electrode mixture layer forming liquid composition drying device is not particularly limited and can be appropriately selected depending on the purpose. Examples thereof include, but are not limited to, a NEO hot plate (manufactured by AS ONE Corp.).

Various conditions in the electrode mixture layer forming liquid composition drying step are not particularly limited and can be appropriately selected depending on the purpose. For example, the drying time can be shortened by setting the temperature as high as possible within the heat resistance temperature of the electrode material.

The electrode having a desired shape can be formed by alternately repeating the electrode mixture layer forming liquid composition application step and the electrode mixture layer forming liquid composition drying step. However, from the viewpoint of having good binding properties, it is preferable to perform the electrode mixture layer forming liquid composition drying step once. Although the reason why the binding properties improve is unclear, it is presumed that the multiple times of the electrode mixture layer forming liquid composition application step cause an interface to be generated inside the electrode, which reduces the film strength and inhibits the formation of electron/ion conductive paths.

### Other Steps and Other Devices

The other steps are not particularly limited and can be appropriately selected depending on the purpose. Examples of the other steps include, but are not limited to, a pressing step.

The other devices are not particularly limited and can be appropriately selected depending on the purpose. Examples the other devices include, but are not limited to, a pressing device.

The pressing step is a step of further pressing the electrode obtained by the method for producing an electrode.

The pressing device is a device for further pressing the electrode obtained by the method for producing an electrode.

In the pressing step, the convex portion is pressed strongly to give a high volume density, and the concave portion is pressed weakly to give a low volume density, resulting in the electrode mixture layer with a periodic sparse-dense structure. This can be confirmed by SEM observation. Thus, even after pressing, the electrolyte liquid permeability to the electrode mixture layer is maintained by converting the periodic concave-convex structure on the electrode mixture layer surface to the periodic porosity difference inside the electrode mixture layer. Since the average volume density of the electrode mixture layer is increased, the electrode with excellent volume energy density is obtained. Further, since the electron resistance is reduced, the rate characteristic is improved.

The pressing device is not particularly limited and can be appropriately selected depending on the purpose. Examples of the pressing device include, but are not limited to, a 7t hydraulic roll press machine (manufactured by Thank Metal).

The press conditions are not particularly limited and can be appropriately selected depending on the purpose. For example, it is possible that the film thickness that results in the desired basis weight is calculated backward, and then this value is set as a gap for pressing.

Embodiments of the present invention are described with reference to the drawings. However, the present invention is not limited to these embodiments.

Note that, in each drawing, the same components are given the same reference numerals, and duplicated description thereof may be omitted. In addition, the number, position, shape, and the like of the constituent members are not limited to the present embodiments, and the number, position, shape, and the like may be any number, position, shape, and the like preferable for implementing the present invention.

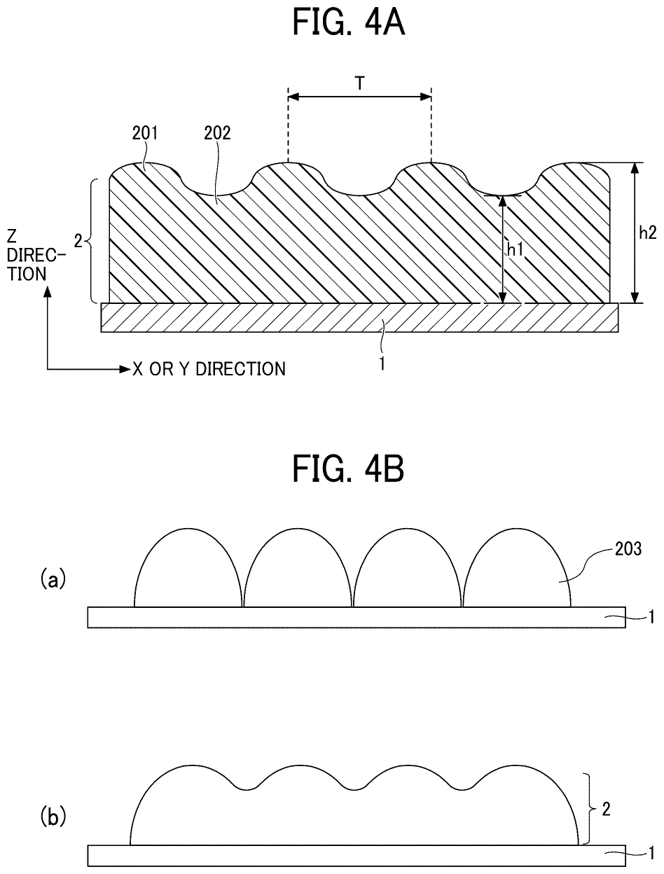

FIG. 4A is a schematic cross-sectional diagram illustrating an electrode obtained by a method for producing an electrode according to one embodiment of the present invention.

As illustrated in FIG. 4A, the electrode includes a substrate 1 and an electrode mixture layer 2 provided on the substrate 1.

The electrode mixture layer 2 has an electrode concave-convex periodic structure in a cross section at least in one direction perpendicular to the thickness direction. The electrode concave-convex periodic structure includes a plurality of convex portions 201 and a plurality of concave portions 202 located between the adjacent convex portions 201 in the cross section in the one direction.

In the present specification, in the electrode concave-convex periodic structure, one period T is defined by a distance from the apex of one convex portion to the apex of the adjacent convex portion or a distance from the apex of one concave portion to the apex of the adjacent concave portion.

A mechanism by which the electrode concave-convex periodic structure is formed on the electrode obtained by the method for producing an electrode according to an embodiment of the present invention is described with reference to FIG. 4B.

FIG. 4B is a schematic cross-sectional diagram for describing the mechanism by which the electrode concave-convex periodic structure is formed on the electrode obtained by the method for producing an electrode according to one embodiment of the present invention.

FIG. 4B(a) is a schematic cross-sectional diagram illustrating a state immediately after an electrode mixture layer forming liquid composition 203 is applied onto the substrate 1. The electrode mixture layer forming liquid composition 203 applied onto the substrate 1 spreads out (i.e., leveling) as a liquid over time on the substrate and coalesces with adjacent droplets as illustrated in FIG. 4B(b), thereby forming the electrode mixture layer 2. A region created by the coalescence of the droplets forms the concave portion, and a region directly below the droplet ejection position forms the convex portion.

In the electrode obtained by the method for producing an electrode according to an embodiment of the present invention, a ratio (h1/h2) of a height h1 (μm) of the convex portion of the electrode mixture layer relative to a height h2 (μm) of the concave portion of the electrode mixture layer is 0.71 or more and 0.95 or less.

When the ratio (h1/h2) is 0.71 or more, a micro-short circuit at the apex of the convex portion is prevented, and the peel strength is improved, so that problems such as a short circuit during laminating or charging/discharging can be solved.

When the ratio (h1/h2) is 0.95 or less, the concave-convex difference is large, and a sufficient contact area is obtained, so that the absorption surface of the electrolyte is increased, and transportation into the electrolyte phase is improved. Thus, the electrode with the excellent rate characteristic can be obtained.

When the electrode mixture layer is pressed, the porosity of the convex portion becomes lower than that of the concave portion, resulting in a structure in which the porosity changes periodically. A portion with high porosity has high electrolyte liquid permeability and thus has high ionic conductivity, while a portion with low porosity has a small interparticle distance of the conductive assistant and thus has high electronic conductivity. When the ratio (h1/h2) is 0.85 and more and 1 or less, a particularly effective improvement of the rate characteristic can be expected.

A method for measuring the height of the convex portion and the concave portion of the electrode mixture layer is not particularly limited and can be appropriately selected depending on the purpose. One example is presented below.

Observation is performed using a laser microscope VK-X3000 (manufactured by Keyence Corp.) equipped with a white light interferometer to obtain a cross-sectional concave-convex profile and calculate the height hl and the height h2.

### Volume Density

In the electrode obtained by the method for producing an electrode, the volume density is not particularly limited and can be appropriately selected depending on the purpose. For the positive electrode, from the viewpoint of forming a conductive path, the volume density is preferably 2 g/cm³ or more, more preferably 3 g/cm³ or more. Further, from the viewpoint of forming an ion conductive path, the volume density is preferably 4 g/cm³ or less, more preferably 3.5 g/cm³ or less.

For the negative electrode, from the viewpoint of forming a conductive path, the volume density is preferably 2 g/cm³ or more, more preferably 2.5 g/cm³ or more. Further, from the viewpoint of forming an ion conductive path, the volume density is preferably 4 g/cm³ or less, more preferably 3.5 g/cm³ or less.

A method for measuring the volume density is not particularly limited and can be appropriately selected depending on the purpose. One example is presented below.

Several electrodes are each punched out using a punch with a diameter Φ of about 10 to 16 mm, and the weight of the electrode including the substrate is measured. The weight of the substrate is determined by punching out only the substrate in advance and measuring the weight of the punched-out substrate. This value is subtracted from the weight of the electrode. The cross section of the punched-out electrode is measured using a laser microscope VK-X3000 (manufactured by Keyence Corp.) equipped with a white light interferometer to calculate the average film thickness. The volume density is calculated as follows: weight of electrode portion/(average film thickness×electrode surface area).

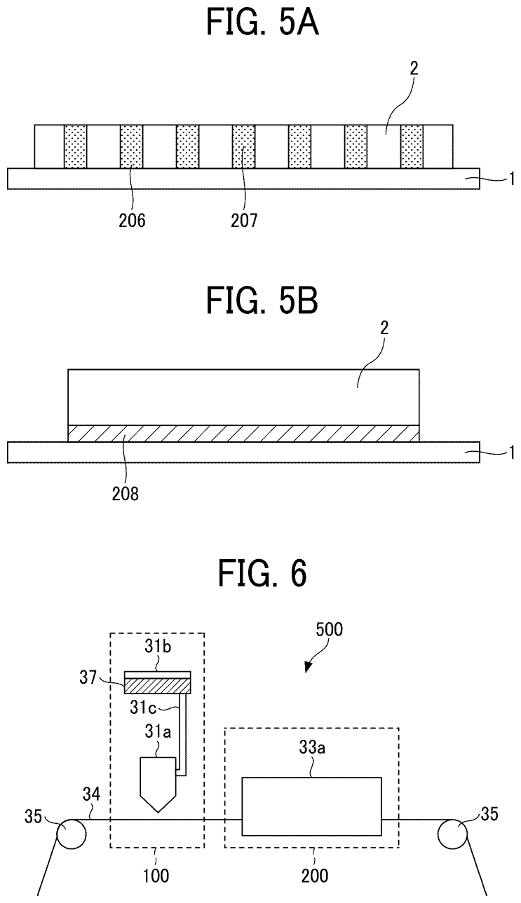

FIG. 5A is a schematic cross-sectional diagram illustrating an electrode obtained by a method for producing an electrode according to one embodiment of the present invention.

The electrode mixture layer 2 may include an opening 206 as illustrated in FIG. 5A.

The number of openings 206 is preferably one or more, more preferably more than one.

The opening 206 may penetrate the electrode mixture layer from the electrode mixture layer surface to the substrate surface, or may not penetrate to the substrate surface.

The opening 206 may be hollow or filled with a material 207. When the opening 206is filled with the material 207, the material 207 may be a single type or a mixture of two or more types. In either case, the material is different from the material constituting the electrode mixture layer. The material 207 is preferably a material having a solid electrolyte from the viewpoint of improving ion conductivity.

The electrode mixture layer including the opening 206 can be suitably produced by using an inkjet device as an electrode mixture layer forming device for its easy application control.

FIG. 5B is a schematic cross-sectional diagram illustrating an electrode obtained by a method for producing an electrode according to an embodiment of the present invention.

As illustrated in FIG. 5B, the electrode may include an adhesion layer 208 containing a metal that alloys with lithium between the substrate 1 and the electrode mixture layer 2.

### Embodiment in which Electrode Mixture Layer is Formed by Directly Applying Electrode Mixture Layer Forming Liquid Composition to Substrate

FIG. 6 is a schematic diagram illustrating an electrode production apparatus according to one embodiment of the present invention.

An electrode production apparatus 500 is an apparatus for producing the electrode mixture layer using the electrode mixture layer forming liquid composition. The electrode production apparatus 500 includes a printing device 100 that applies the electrode mixture layer forming liquid composition onto a printing substrate 34 to form an electrode mixture layer forming liquid composition layer, and a heating device 200 as necessary. The electrode production apparatus 500 includes a conveying unit 35 that conveys the printing substrate 34, and the conveying unit 35 conveys the printing substrate 34 at a preset speed through the printing device 100 and the optional heating device 200 in this order.

### Printing Device 100

The printing device 100 includes a printing unit 31a, which is an example of the electrode mixture layer forming liquid composition application device that applies the electrode mixture layer forming liquid composition to form the electrode mixture layer on the printing substrate 34, a storage container 31b that stores the electrode mixture layer forming liquid composition, and a supply tube 31c that supplies an electrode mixture layer forming liquid composition 37 stored in the storage container 31b to the printing unit 31a.

The storage container 31b stores the electrode mixture layer forming liquid composition 37, and the printing device 100 ejects the electrode mixture layer forming liquid composition 37 from the printing unit 31a to form the electrode mixture layer forming liquid composition layer as a thin film on the printing substrate 34. Note that the storage container 31b may be integrated with the electrode production apparatus or may be removable from the electrode production apparatus. Further, the storage container 31b may be a container used for adding the liquid composition to a storage container integrated with the electrode production apparatus or a storage container removable from the electrode production apparatus.

The storage container 31b and the supply tube 31c can be freely selected as long as they can stably store and supply the electrode mixture layer forming liquid composition 37.

### Heating Device 200

As illustrated in FIG. 6, the heating device 200 includes a heating unit 33a and performs the electrode mixture layer forming liquid composition drying step in which the electrode mixture layer forming liquid composition layer formed by the printing device 100 is heated by the heating unit 33a to dry the remaining liquid. This allows the electrode mixture layer to be formed. The heating device 200 may remove the liquid under reduced pressure.

The heating unit 33a is not particularly limited and can be appropriately selected depending on the purpose. Examples thereof include, but are not limited to, an IR heater and a hot air heater.

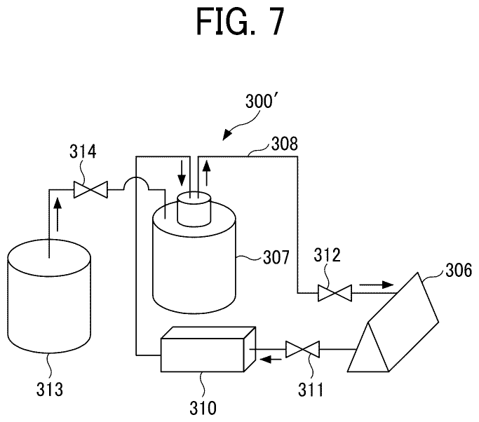

FIG. 7 is a schematic diagram illustrating an electrode production apparatus according to an embodiment of the present invention.

A liquid ejection device 300′ can circulate the electrode mixture layer forming liquid composition through a liquid ejection head 306, a tank 307, and a tube 308 by controlling a pump 310, a valve 311, and a valve 312.

Further, the liquid ejection device 300′ is provided with an external tank 313, and when the electrode mixture layer forming liquid composition in the tank 307 decreases, the liquid ejection device 300′ can supply the electrode mixture layer forming liquid composition from the external tank 313 to the tank 307 by controlling the pump 310, the valve 311, the valve 312, and a valve 314.

By using such an electrode manufacturing apparatus, the electrode mixture layer forming liquid composition can be ejected to a targeted location on the substrate.

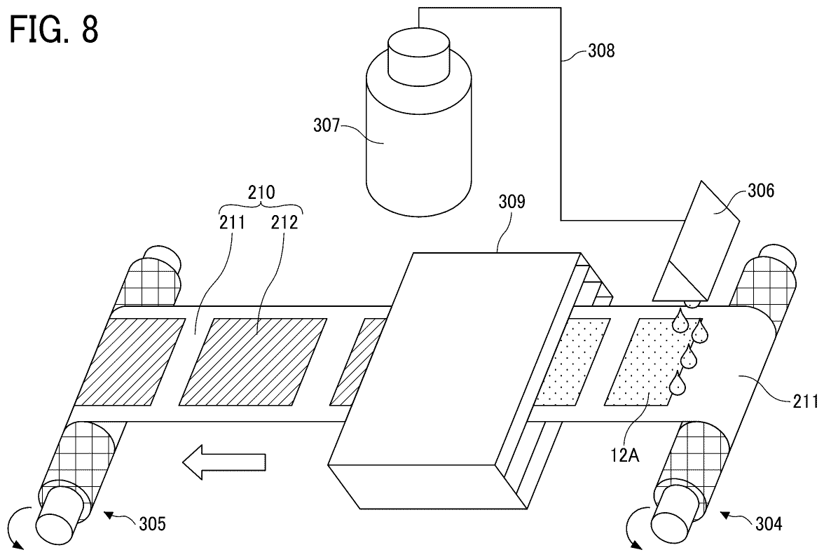

FIG. 8 is a schematic diagram illustrating an electrode production apparatus according to an embodiment of the present invention.

The method for producing an electrode includes a step of sequentially ejecting an electrode mixture layer forming liquid composition 12A onto a substrate 211 using a liquid ejection device.

First, the substrate 211 having an elongated shape is prepared. Then, the substrate 211 is wound around a cylindrical core and set on a delivery roller 304 and a take-up roller 305 so that the side on which the electrode mixture layer is to be formed is the upper side in FIG. 8. In this configuration, the delivery roller 304 and the take-up roller 305 rotate counterclockwise in FIG. 8, and the substrate 211 is transported from right to left in FIG. 8. Then, droplets of the electrode mixture layer forming liquid composition 12A are ejected from the liquid ejection head 306 installed above the substrate 211 between the delivery roller 304 and the take-up roller 305 onto the substrate 211 being transported sequentially in the same manner as in FIG. 7.

Note that a plurality of the liquid ejection heads 306 may be installed in a direction substantially parallel or substantially perpendicular to the transport direction of the substrate 211. Next, the substrate 211 onto which the droplets of the electrode mixture layer forming liquid composition 12A have been ejected is transported to a heating device 309 by the delivery roller 304 and the take-up roller 305. As a result, an electrode mixture layer 212 is formed, and an electrode 210 having the electrode mixture layer 212 provided on the substrate 211 is obtained.

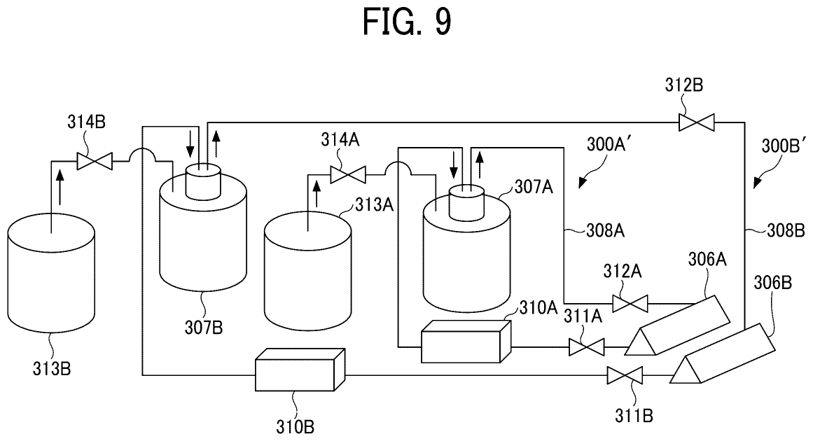

FIG. 9 is a schematic diagram illustrating a modification of an electrode production apparatus according to an embodiment of the present invention.

As illustrated in FIG. 9, a liquid ejection device 300A′ and a liquid ejection device 300B′ may be used in combination. That is, the electrode mixture layer forming liquid composition may be supplied from an external tank 313A and an external tank 313B connected to a tank 307A and a tank 307B, respectively, and the liquid ejection head may include a plurality of heads 306A and 306B. Accordingly, tubes 308A and 308B, valves 311A and 311B, valves 312A and 312B, valves 314A and 314B, and pumps 310A and 310B may be provided.

### Embodiment in which Electrode Mixture Layer is Formed by Indirectly Applying Electrode Mixture Layer Forming Liquid Composition to Substrate

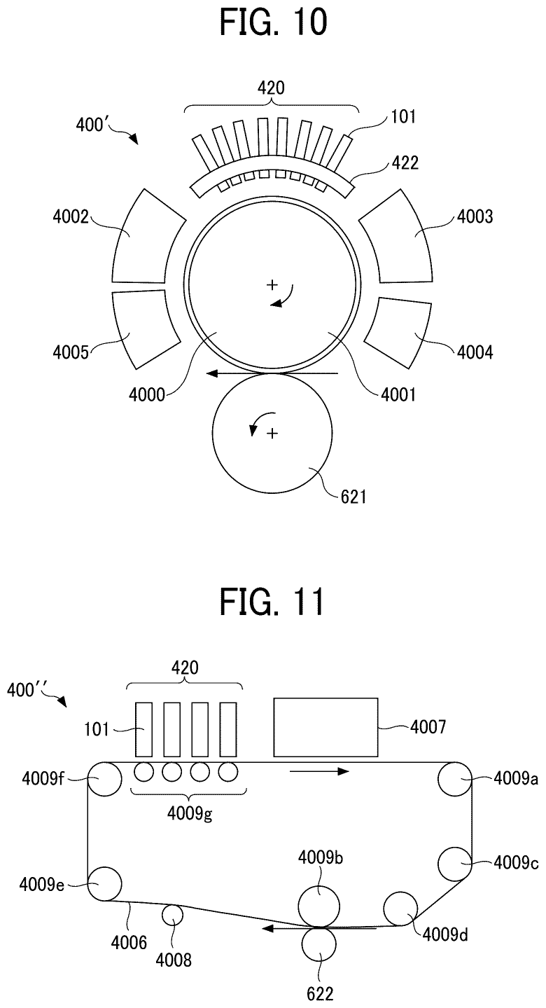

FIG. 10 is a configuration diagram illustrating a printing device including an electrode mixture layer forming liquid composition application device employing an inkjet method and a transfer method, in an electrode production apparatus according to one embodiment of the present invention. An intermediate transfer body having a drum shape is used in the printing device in FIG. 10.

A printing device 400′ is an inkjet printer that forms the electrode mixture layer on the substrate by transferring the electrode mixture layer forming liquid composition to the substrate via an intermediate transfer body 4001.

The printing device 400′ includes an inkjet unit 420, a transfer drum 4000, a pretreatment unit 4002, an absorbing unit 4003, a heating unit 4004, and a cleaning unit 4005.

The inkjet unit 420 includes a head module 422 that holds a plurality of heads 101.

The head 101 ejects the electrode mixture layer forming liquid composition to the intermediate transfer body 4001 supported by the transfer drum 4000, forming an electrode mixture layer forming liquid composition film on the intermediate transfer body 4001. Each head 101 is a line head, and nozzles are arranged in a range that covers the width of the recording region of the maximum size of the substrate that can be used. The head 101 includes, on its lower surface, a nozzle surface in which a nozzle is formed. The nozzle surface faces the surface of the intermediate transfer body 4001 with a minute gap interposed therebetween. In the present embodiment, the intermediate transfer body 4001 is configured to circulate on a circular trajectory, so that the plurality of heads 101 are arranged radially.

The transfer drum 4000 faces an impression cylinder 621 to form a transfer nip. The pretreatment unit 4002 applies, for example, a reaction liquid for increasing the viscosity of the electrode mixture layer forming liquid composition onto the intermediate transfer body 4001 before the head 101 ejects the electrode mixture layer forming liquid composition.

The absorbing unit 4003 absorbs a liquid component from the electrode mixture layer forming liquid composition on the intermediate transfer body 4001 before transfer.

The heating unit 4004 heats the electrode mixture layer forming liquid composition on the intermediate transfer body 4001 before transfer. Heating the electrode mixture layer forming liquid composition allows the electrode mixture layer to be formed. Further, heating removes the solvent, thereby improving transferability to the substrate.

The cleaning unit 4005 cleans the surface of the intermediate transfer body 4001 after transfer and removes remaining ink and foreign matter such as dust on the intermediate transfer body 4001.

The outer peripheral surface of the impression cylinder 621 is in pressure contact with the intermediate transfer body 4001, and the electrode mixture layer on the intermediate transfer body 4001 is transferred to the substrate when the substrate passes through the transfer nip between the impression cylinder 621 and the intermediate transfer body 4001. Note that the impression cylinder 621 may be configured to include at least one gripping mechanism for holding the leading end of the substrate on its outer peripheral surface.

FIG. 11 is a configuration diagram illustrating a printing device including an electrode mixture layer forming liquid composition application device employing an inkjet method and a transfer method, in an electrode production apparatus according to one embodiment of the present invention. The printing device in FIG. 11 uses the intermediate transfer body in the form of an endless belt.

A printing device 400″ is an inkjet printer that forms the electrode mixture layer by transferring the electrode mixture layer forming liquid composition onto the substrate via an intermediate transfer belt 4006.

The printing device 400″ includes an inkjet unit 420, a transfer roller 622, the intermediate transfer belt 4006, a heating unit 4007, a cleaning roller 4008, a driving roller 4009a, an opposing roller 4009b, a shape-maintaining roller 4009c, a shape-maintaining roller 4009d, a shape-maintaining roller 4009e, and a shape-maintaining roller 4009f.

The printing device 400″ ejects droplets of the electrode mixture layer forming liquid composition onto the outer peripheral surface of the intermediate transfer belt 4006 from the plurality of heads 101 provided in the inkjet unit 420. The electrode mixture layer forming liquid composition on the intermediate transfer belt 4006 is heated by the heating unit 4007 and thermally polymerized to form the electrode mixture layer. In the transfer nip where the intermediate transfer belt 4006 faces the transfer roller 622, the electrode mixture layer on the intermediate transfer belt 4006 is transferred to the substrate. The surface of the intermediate transfer belt 4006 after transfer is cleaned by the cleaning roller 4008.

The intermediate transfer belt 4006 is stretched over the driving roller 4009a, the opposing roller 4009b, the plurality of shape-maintaining rollers 4009c, 4009d, 4009e, and 4009f, and a plurality of support rollers 4009g, and moves in an arrow direction in FIG. 11. The support rollers 4009g, which are provided to face the heads 101, maintain a tension state of the intermediate transfer belt 4006 when ink droplets are ejected from the heads 101.

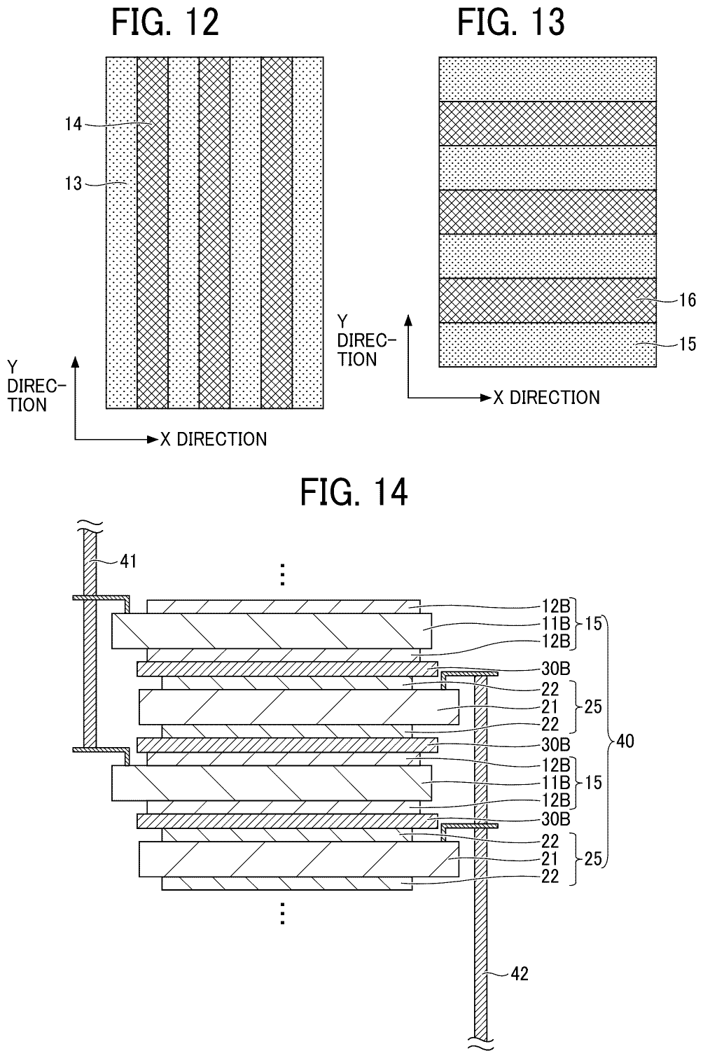

FIG. 12 is a schematic diagram illustrating an example of a formation pattern of the electrode mixture layer in a method for producing an electrode according to one embodiment of the present invention. FIG. 13 is a schematic diagram illustrating an example of a formation pattern of the electrode mixture layer in a method for producing an electrode according to one embodiment of the present invention.

In FIG. 12 and FIG. 13, an X direction is perpendicular to the printing direction and parallel to the substrate surface, and a Y direction is the printing direction. Patterning the electrode mixture layer in this manner increases the surface area.

FIG. 12 illustrates the electrode mixture layer in which a convex region 13 and a concave region 14 are periodically formed. The electrode mixture layer is flat in the Y direction.

FIG. 13 illustrates the electrode mixture layer in which a convex region 15 and a concave region 16 are periodically formed in the Y direction. The electrode mixture layer is flat in the X direction.

### Electrochemical Element

An electrochemical element according to an embodiment of the present invention includes an electrode obtained by a method for producing an electrode according to an embodiment of the present invention and may further include other members as necessary. In other words, an electrochemical element according to an embodiment of the present invention may include a positive electrode, a negative electrode, an electrolyte, a separator having the electrolyte disposed between the positive electrode and the negative electrode, and an exterior.

Note that, when a solid electrolyte or a gel electrolyte is used, the separator is not necessary.

As a method for producing the electrochemical element, a publicly known method can be appropriately selected, except that the electrode is obtained using the method for producing an electrode according to an embodiment of the present invention.

### Electrolyte

As an electrolyte, an aqueous electrolyte solution or a non-aqueous electrolyte liquid can be used.

### Aqueous Electrolyte Solution

The aqueous electrolyte solution is an aqueous solution in which an electrolyte salt is dissolved in water.

The electrolyte salt in the aqueous electrolyte solution is not particularly limited and can be appropriately selected depending on the purpose. Examples of the electrolyte salt include, but are not limited to, sodium hydroxide, potassium hydroxide, sodium chloride, potassium chloride, ammonium chloride, zinc chloride, zinc acetate, zinc bromide, zinc iodide, zinc tartrate, and zinc perchlorate.

### Non-Aqueous Electrolyte

As a non-aqueous electrolyte, a non-aqueous electrolyte liquid, a solid electrolyte, or a gel electrolyte can be used.

### Non-Aqueous Electrolyte Liquid

The non-aqueous electrolyte liquid is an electrolyte liquid in which an electrolyte salt is dissolved in a non-aqueous solvent.

The non-aqueous solvent is not particularly limited and can be appropriately selected depending on the purpose. For example, it is preferable to use an aprotic organic solvent. As the aprotic organic solvent, a carbonate-based organic solvent such as a chain carbonate or a cyclic carbonate can be used. Of these, a chain carbonate is preferable because it has a high dissolving power for an electrolyte salt. Further, the aprotic organic solvent is preferable because it has a low viscosity.

Examples of the chain carbonate include, but are not limited to, dimethyl carbonate (DMC), diethyl carbonate (DEC), and methyl ethyl carbonate (EMC).

The content of the chain carbonate in the non-aqueous solvent is preferably 50% by mass or more. When the content of the chain carbonate in the non-aqueous solvent is 50% by mass or more, even if the non-aqueous solvent other than the chain carbonate is a cyclic substance (e.g., cyclic carbonate or cyclic ester) having a high dielectric constant, the content of the cyclic substance becomes small. As a result, even if a non-aqueous electrolyte liquid with a high concentration of 2 M or more is produced, the viscosity of the non-aqueous electrolyte liquid is low, which improves permeation of the non-aqueous electrolyte liquid into the electrode and ion diffusion.

Examples of the cyclic carbonate include, but are not limited to, propylene carbonate (PC), ethylene carbonate (EC), butylene carbonate (BC), and vinylene carbonate (VC).

Note that examples of the non-aqueous solvent that can be used other than the carbonate-based organic solvent include, but are not limited to: an ester-based organic solvents such as a cyclic ester or a chain ester; and an ether-based organic solvent such as a cyclic ether or a chain ether.

Examples of the cyclic ester include, but are not limited to, γ-butyrolactone (γBL), 2-methyl-γ-butyrolactone, acetyl-γ-butyrolactone, and γ-valerolactone.

Examples of the chain ester include, but are not limited to, an ester of alkyl propionate, an ester of dialkyl malonate, an ester of alkyl acetate (e.g., methyl acetate (MA) or ethyl acetate), and an ester of alkyl formate (e.g., methyl formate (MF) or ethyl formate).

Examples of the cyclic ether include, but are not limited to, tetrahydrofuran, alkyltetrahydrofuran, alkoxytetrahydrofuran, dialkoxytetrahydrofuran, 1,3-dioxolane, alkyl-1,3-dioxolane, and 1,4-dioxolane.

Examples of the chain ether include, but are not limited to, 1,2-dimethoxyethane (DME), diethyl ether, ethylene glycol dialkyl ether, diethylene glycol dialkyl ether, triethylene glycol dialkyl ether, and tetraethylene glycol dialkyl ether.

The electrolyte salt in the non-aqueous electrolyte liquid is not particularly limited, as long as it has high ionic conductivity and can be dissolved in the non-aqueous solvent.

The electrolyte salt in the non-aqueous electrolytic solution preferably includes a halogen atom.

Examples of a cation constituting the electrolyte salt include, but are not limited to, a lithium ion.

Examples of an anion constituting the electrolytic salt include, but are not limited to, BF₄⁻, PF₆⁻, AsF₆⁻, CF₃SO₃⁻, (CF₃SO₂)₂N⁻, and (C₂F₅SO₂)₂N⁻.

Examples of the lithium salt include, but are not limited to, lithium hexafluorophosphate (LiPF₆), lithium fluoroborate (LiBF₄), lithium hexafluoroarsenate (LiAsF₆), lithium trifluoromethasulfonate (LiCF₃SO₃), lithium bis(trifluoromethylsulfonyl)imide (LiN(C₃SO₂)₂), and lithium bis (pentafluoroethylsulfonvl)imide (LiN(C₂F₅SO₂)₂). Of these, LiPF₆ is preferable from the viewpoint of ion conductivity, and LiBF₄ is preferable from the viewpoint of stability.

The electrolyte salt in the non-aqueous electrolyte liquid may be used alone or in combination of two or more types.

The concentration of the electrolyte salt in the non-aqueous electrolyte liquid is not particularly limited and can be appropriately selected depending on the purpose. However, when the non-aqueous electrochemical element is of a swing type, the concentration is preferably 1 mol/L to 2 mol/L, and when the non-aqueous electrochemical element is of a reserve type, the concentration is preferably 2 mol/L to 4 mol/L.

### Solid Electrolyte

As the solid electrolyte, the same as those described in <<Solid electrolyte>> can be used.

### Gel Electrolyte

The gel electrolyte is not particularly limited and can be appropriately selected depending on the purpose, as long as it exhibits ion conductivity. Examples of a polymer constituting a network structure of the gel electrolyte include, but are not limited to, polyethylene oxide, polypropylene oxide, polyacrylonitrile, polymethyl methacrylate, polyvinyl chloride, a copolymer of vinylidene fluoride and propylene hexafluoride, and polyethylene carbonate.

A solvent molecule held in the gel electrolyte is not particularly limited and can be appropriately selected depending on the purpose. Example of the solvent molecule include, but are not limited to, an ionic liquid.

Examples of the ionic liquid include, but are not limited to, 1-methyl-1-propylpyrrolidinium bis(fluorosulfonylimide), 1-butyl-1-methylpyrrolidinium bis(fluorosulfonylimide), 1-methyl-1-propylpiperidinium bis(fluorosulfonylimide), 1-ethyl-3-methylimidazolium bis(fluorosulfonylimide), 1-methyl-3-propylimidazolium bis(fluorosulfonylimide), and N,N-diethyl-N-methyl-N-(2-methoxyethyl)ammonium bis(fluorosulfonyl) imide.

Further, a mixture of a lithium salt and a liquid such as tetraglyme, propylene carbonate, fluoroethylene carbonate, ethylene carbonate, or diethyl carbonate may be used.

These gel electrolytes may be used alone or in combination of two or more types.

As an electrolyte material that is dissolved or dispersed in a liquid for constituting the gel electrolyte, a polymer compound and an ionic liquid or a solution in which a lithium salt is dissolved may be used. Further, a material that is a precursor of the gel electrolyte, such as, for example, polyethylene oxide or polypropylene oxide having acrylate groups at both ends, may be used in combination with an ionic liquid or a solution in which a lithium salt is dissolved.

### Separator

The separator is provided between a negative electrode and a positive electrode as necessary to prevent a short circuit between the negative electrode and the positive electrode.

Examples of the separator include, but are not limited to: a paper such as a kraft paper, a vinylon-mixed paper, or a synthetic pulp-mixed paper; cellophane; a polyethylene graft membrane; a polyolefin nonwoven fabric such as a polypropylene melt-blown nonwoven fabric; a polyamide nonwoven fabric; a glass fiber nonwoven fabric; and a micropore membrane.

The size of the separator is not particularly limited as long as it can be used in the electrochemical element.

The separator may have a single-layer structure or a laminated structure.

Note that the separator is necessary when an aqueous electrolyte solution or a non-aqueous electrolyte liquid is used as the electrolyte. However, the separator is not necessary when a solid electrolyte or a gel electrolyte is used.

### Exterior

The exterior is not particularly limited, and any known exterior can be appropriately selected depending on the purpose, as long as it can seal the electrode, the electrolyte, and the separator, or the solid electrolyte or the gel electrolyte.

The shape of the electrochemical element is not particularly limited, and example thereof include, but are not limited to, a laminate type, a cylinder type in which a sheet electrode and a separator are spirally wound, a cylinder type with an inside-out structure in which a pellet electrode and a separator are combined, and a coin type in which a pellet electrode and a separator are laminated.

An electrochemical element according to an embodiment of the present invention are described with reference to the drawings.

However, the present invention is not limited to these embodiments.

FIG. 14 is a schematic cross-sectional diagram illustrating an electrochemical element according to one embodiment of the present invention.

In an electrode element 40, a negative electrode 15 and a positive electrode 25 are laminated with a separator 30B interposed therebetween. In this configuration, the positive electrodes 25 are laminated on both sides of the negative electrode 15. Further, a lead wire 41 is connected to a negative electrode substrate 11B, and a lead wire 42 is connected to a positive electrode substrate 21. Note that, for a solid electrochemical element, the separator 30B may be replaced with a solid electrolyte or a gel electrolyte.

In the negative electrode 15, negative electrode mixture layers 12B are formed on both sides of the negative electrode substrate 11B.

In the positive electrode 25, positive electrode mixture layers 22 are formed on both sides of the positive electrode substrate 21.

Note that the number of layers of the negative electrodes 15 and the positive electrodes 25 in the electrode element 40 is not particularly limited and can be appropriately selected depending on the purpose. Further, the number of negative electrodes 15 and the number of positive electrodes 25 in the electrode element 40 may be the same or different.

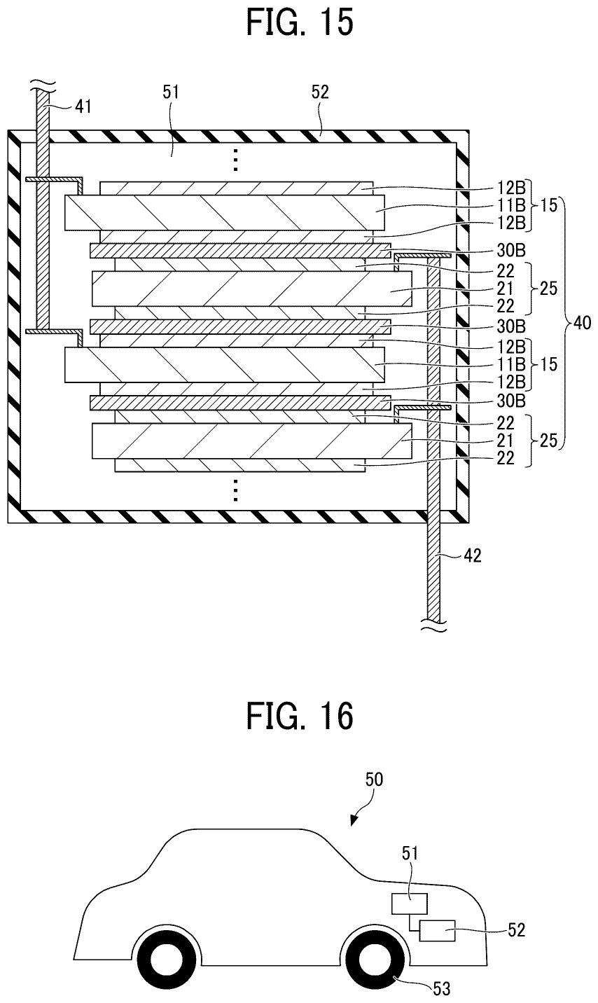

FIG. 15 is a schematic cross-sectional diagram illustrating an electrochemical element according to an embodiment of the present invention.

The electrode element 40 has a configuration similar to that illustrated in FIG. 14. In a case where the electrochemical element is a liquid-based electrochemical element, an electrolyte layer 51 is formed by injecting an aqueous electrolyte solution or a non-aqueous electrolyte into the electrode element 40, and the electrochemical element is sealed with an exterior 52. In the electrochemical element, the lead wire 41 and the lead wire 42 are led out of the exterior 52.

Further, in a case where the electrochemical element is a solid electrochemical element, the separator 30B may be replaced with a solid electrolyte or a gel electrolyte.

### Electrochemical Element Production Apparatus and Electrochemical Element Production Method

An electrochemical element production apparatus according to an embodiment of the present invention includes an electrode production device for producing an electrode using the electrode production apparatus according to an embodiment of the present invention, and an element formation device for producing an electrochemical element using the electrode, and further includes other devices as necessary.

An electrochemical element production method according to an embodiment of the present invention includes an electrode production step of producing an electrode by the method for producing an electrode according to an embodiment of the present invention, and an element formation step of producing an electrochemical element using the electrode, and further includes other steps as necessary.

### Electrode Production Device and Electrode Production Step

The electrode production device includes a storage container, and an electrode mixture layer forming liquid composition application device for applying an electrode mixture layer forming liquid composition stored in the storage container onto a substrate, and further includes other devices as necessary.

The electrode production step includes an electrode mixture layer forming liquid composition application step of applying an electrode mixture layer forming liquid composition, and further includes other steps as necessary.

The storage container, the electrode mixture layer forming liquid composition application device, and the electrode mixture layer forming liquid composition application step can be appropriately selected from those described in (Method for producing an electrode and electrode production apparatus).

### Element Formation Device and Element Formation Step

The element formation device is a device for producing an electrochemical element using the electrode.

The element formation step is a step of producing an electrochemical element using the electrode.

The method for producing the electrochemical element using the electrode is not particularly limited, and a known method for producing an electrochemical element can be appropriately selected depending on the purpose. Examples thereof include a method for producing an electrochemical element by performing at least one of processes including installation of a counter electrode, winding or lamination, and placement into a container.

Note that the element formation step does not need to include the entire step of forming the element and may include a part of the element formation step, such as an electrode element formation step.

### Use of Electrochemical Element

The electrochemical element can be suitably used as a secondary battery.

Uses of the electrochemical element are not particularly limited, and examples thereof include, but are not limited to, a notebook computer, a pen-input personal computer, a mobile personal computer, an electronic book player, a mobile phone, a mobile fax machine, a mobile copier, a mobile printer, a headphone stereo, a video movie player, an LCD television, a handheld cleaner, a portable CD player, a MiniDisc player, a transceiver, an electronic organizer, a calculator, a memory card, a portable tape recorder, a radio, a backup power source, a motor, lighting equipment, a toy, game equipment, a watch, a strobe, a camera, and a vehicle.

FIG. 16 is a schematic diagram illustrating a moving body that is an electrochemical element according to one embodiment of the present invention.

A moving body 50 is, for example, an electric vehicle. The moving body 50 includes a motor 51, an electrochemical element 52, and wheels 53.

The electrochemical element 52 is an electrochemical element according to an embodiment of the present invention. The electrochemical element 52 drives the motor 51 by supplying power to the motor 51. The driven motor 51 can drive the wheels 53, and as a result, the moving body 50 can move.

Since the moving body 50 is equipped with the electrochemical element 52, it is possible to prevent a short circuit between the positive electrode and the negative electrode and drive the mobile body by the power from the electrochemical element having excellent battery characteristics, thereby moving the mobile body safely and efficiently.

The moving body 50 is not limited to an electric vehicle, but may be a PHEV or HEV, or a locomotive or a motorcycle that can move using a combination of a diesel engine and an electrochemical element. Further, the moving body 50 may be a transport robot used in a factory or the like that can move using only an electrochemical element or a combination of an engine and an electrochemical element. Further, the moving body 50 may be an object which does not move as a whole, but only a part of which moves, such as an assembly robot that is placed on a production line in a factory and can operate an arm or the like by using only an electrochemical element or a combination of an engine and an electrochemical element.

### EXAMPLES

Embodiments of the present invention is specifically described below with Examples and Comparative examples. However, embodiments of the present invention is not limited to these examples. Note that, in the following Examples and Comparative examples, unless otherwise specified, “parts” means “parts by mass” and “%” means “% by mass”.

### Production of Electrode Mixture Layer Forming Liquid Compositions 1 to 18

Solid components (an active material, a binder, a conductive assistant, and a dispersant) were mixed in a dispersion medium with compositions and addition amounts presented in Table 1 and dispersed for 2 minutes using an ultrasonic homogenizer (manufactured by Nippon Seiki Co., Ltd.) to obtain electrode mixture layer forming liquid compositions 1 to 18.

Note that details of each component are as follows.

### Active Material

Gr: Artificial graphite (manufactured by Hitachi Chemical Company, Ltd.)
SiO: Silicon oxide (manufactured by Sigma-Aldrich)
NCM: Lithium nickel cobalt manganese oxide (average primary particle size 3.5 μm, manufactured by Toshima Manufacturing Co., Ltd.)

### Binder

SBR: Styrene-butadiene-rubber (manufactured by Zeon Corp.)
P(DEAmEMA-BMA): Poly (diethylaminoethyl methacrylate-butyl methacrylate) copolymer

### Conductive Assistant

AB: Acetylene black (DENKA BLACK, manufactured by Denka Company Ltd.)
SWCNT: (manufactured by OCSiAl)

### Dispersant

CMC: Carboxymethylcellulose (DKS Co. Ltd.)
BYK-ET3000: (BYK-Chemie GmbH)

### Dispersion Medium

NMP: N-methyl-2-pyrrolidone (manufactured by Tokyo Chemical Industry Co., Ltd.)

Note that P (DEAmEMA-BMA): poly(diethylaminoethyl methacrylate-butyl methacrylate) copolymer was synthesized as follows.

Under a nitrogen stream, degassed toluene was added to a flask and heated to 80° C. A mixed solution consisting of 33 mL of toluene, 25.00 g (175.8 mmol) of butyl methacrylate, 8.14 g (43.95 mmol) of 2-(diethylamino) ethyl methacrylate, and 109 mg (0.440 mmol) of 2,2′-azobis (2,4-dimethylvaleronitrile) was added dropwise to the flask over 1 hour with stirring. After the dropwise addition was completed, the mixture was stirred at 80° C. for 8 hours and allowed to cool to room temperature. The reaction solution was then added dropwise to methanol, and a precipitate was collected by decantation and vacuum dried to synthesize a copolymer with a weight-average molecular weight of 113,000.

TABLE 1

| Electrode | | | | | | | | | | | | | | |
|---|---|---|---|---|---|---|---|---|---|---|---|---|---|---|
| mixture | | | | | | | | | | | | | Solid | |
| layer | | | | | | | | | Dispersion medium | | | | content | Vis- |
| forming | Active material | | Binder | | Conductive assistant | | Dispersant | | | | Water | | concen- | cosity |
| liquid | | Mass | | Mass | | Mass | | Mass | | Boiling | content | Mass | tration | [mPa · |
| composition | Material | ratio | Material | ratio | Material | ratio | Material | ratio | Material | point | [ppm] | ratio | [wt %] | s] |
| 1 | Gr: SiO | 80:20 | SBR | 5.0 | AB | 1.0 | CMC | 1.00 | Water | 100 | — | 71 | 60 | 195 |
| 2 | | | | | | | | | | 100 | — | 82 | 55 | 145 |
| 3 | | | | | | | | | | 100 | — | 100 | 50 | 100 |
| 4 | | | | | | | | | | 100 | — | 122 | 45 | 70 |
| 5 | | | | | | | | | | 100 | — | 150 | 40 | 40 |
| 6 | | | | | | | | | | 100 | — | 186 | 35 | 20 |
| 7 | | | | | | | | | | 100 | — | 233 | 30 | 15 |
| 8 | Gr: SiO | 80:20 | SBR | 5 | SW CNT | 0.03 | CMC | 1.00 | Water | 100 | — | 159 | 40 | 60 |
| 9 | Gr: SiO | 80:20 | SBR | 5 | SW CNT:AB | 0.02:0.5 | CMC | 1.00 | Water | 100 | — | 160 | 40 | 60 |
| 10 | Gr | 100 | SBR | 5 | SW CNT | 0.03 | CMC | 1.00 | Water | 100 | — | 159 | 40 | 70 |
| 11 | SiO | 100 | SBR | 5 | SW CNT | 0.03 | CMC | 1.00 | Water | 100 | — | 159 | 40 | 50 |
| 12 | NCM | 100 | P (BMA- | 1.5 | AB | 3.0 | BYK- | 0.20 | NMP | 202 | 10 | 41 | 72 | 180 |
| 13 | | | DEAm | | | | ET3000 | | | 202 | 10 | 43 | 70 | 150 |
| 14 | | | EMA) | | | | | | | 202 | 10 | 47 | 68 | 100 |
| 15 | | | | | | | | | | 202 | 10 | 52 | 66 | 70 |
| 16 | | | | | | | | | | 202 | 10 | 59 | 63 | 40 |
| 17 | | | | | | | | | | 202 | 10 | 67 | 60 | 20 |
| 18 | | | | | | | | | | 202 | 10 | 82 | 55 | 15 |

### Electrode Production Example 1

A valve head-type nozzle disclosed in Japanese Patent No. 7271956 was attached to an inkjet ejection evaluation device (device name: EV2500, manufactured by Ricoh Co., Ltd.), and the electrode mixture layer forming liquid composition was applied onto the substrate at the application period, nozzle diameter, and pass number (number of times for the electrode mixture layer forming liquid composition application step and the electrode mixture layer forming liquid composition drying step) described in Table 2. After application, the liquid composition was dried on a hot plate to obtain an electrode. Note that the valve head-type nozzle is disposed perpendicularly to the substrate transport direction in the inkjet ejection evaluation device.

Note that, in a case where the electrode mixture layer forming liquid composition is used for the negative electrode, the substrate was a 15 μm copper foil, the drying temperature was 80° C., and the basis weight was 7 mg/cm². In a case for the positive electrode, the substrate was an aluminum foil, the drying temperature was 120° C., and the basis weight was 20 mg/cm².

### Electrode Production Examples 2 to 10

Electrodes were obtained in the same manner as in Electrode production example 1, except that the conditions were changed as presented in Table 2.

### Electrode Production Example 11

Electrode production example 11 is an example of producing an electrode having a concave-convex structure by pressing a flat electrode with a concave-convex mold with reference to Japanese Unexamined Patent Application Publication No. 2015-138619.

For applying the electrode mixture layer forming liquid composition onto the substrate, the electrode mixture layer forming liquid composition was applied by a die coating method and then dried to form a flat electrode mixture layer. Next, a press processing was performed using the concave-convex mold with a periodic pitch of 1.27 μm to obtain an electrode having a concave-convex structure.

Note that, in a case where the electrode mixture layer forming liquid composition was used for the negative electrode, the substrate was a 15 μm copper foil, the drying temperature was 80° C., and the basis weight was 7 mg/cm². In a case for the positive electrode, the substrate was an aluminum foil, the drying temperature was 120° C., and the basis weight was 20 mg/cm².

### Electrode Production Example 12

Electrode production example 12 is a production example of obtaining an electrode having a concave-convex structure by applying, onto a flat electrode of first layer, an electrode of second layer having a concave-convex structure with reference to Japanese Unexamined Patent Application Publication No. 2013-051209.

For applying the electrode mixture layer forming liquid composition onto the substrate, the electrode mixture layer forming liquid composition was applied by a die coating method and then dried to form a flat electrode mixture layer. Next, the electrode of second layer having a concave-convex structure obtained by the same operation as in Electrode production example 1 was applied onto the electrode of first layer thus obtained.

Note that, in a case where the electrode mixture layer forming liquid composition was used for the negative electrode, the substrate was a 15 μm copper foil, the drying temperature was 80° C., and the basis weight was 7 mg/cm². In a case for the positive electrode, the substrate was an aluminum foil, the drying temperature was 120° C., and the basis weight was 20 mg/cm².

### Electrode Production Example 13

Electrode production example 13 is a production example of obtaining an electrode having a concave-convex structure using an inkjet printing device with reference to Japanese Unexamined Patent Application Publication No. 2023-138315.

Using an inkjet device (device name: EV2500, nozzle name: MH2810-F, manufactured by Ricoh Co., Ltd.), the electrode mixture layer forming liquid composition was applied onto a heated substrate and dried. This was repeated a total of 10 passes, and an electrode having a concave-convex structure was obtained by locally changing the application amount for each nozzle.

Note that in a case where the electrode mixture layer forming liquid composition was used for the negative electrode, the substrate was a 15 μm copper foil, the drying temperature was 80° C., and the basis weight was 7 mg/cm². In a case for the positive electrode, the substrate was an aluminum foil, the drying temperature was 120° C., and the basis weight was 20 mg/cm².

TABLE 2

| | | Conditions when application method is | | | |
|---|---|---|---|---|---|
| | | “IJ Printing” or “VJ Printing” | | | |
| | | | Nozzle | Application | |
| | Application | Nozzle | diameter | period | Pass |
| | method | type | [mm] | [mm] | number |
| Production | IJ printing | Valve type | 0.15 | 1.27 | 1 |
| example 1 | | nozzle | | | |
| Production | IJ printing | Valve type | 0.10 | 1.27 | 1 |
| example 2 | | nozzle | | | |
| Production | IJ printing | Valve type | 0.07 | 1.27 | 1 |
| example 3 | | nozzle | | | |
| Production | IJ printing | Valve type | 0.15 | 2.54 | 1 |
| example 4 | | nozzle | | | |
| Production | IJ printing | Valve type | 0.15 | 1.69 | 1 |
| example 5 | | nozzle | | | |
| Production | IJ printing | Valve type | 0.15 | 0.85 | 1 |
| example 6 | | nozzle | | | |
| Production | IJ printing | Valve type | 0.15 | 0.64 | 1 |
| example 7 | | nozzle | | | |
| Production | IJ printing | Valve type | 0.15 | 0.42 | 1 |
| example 8 | | nozzle | | | |
| Production | IJ printing | Valve type | 0.15 | 0.28 | 1 |
| example 9 | | nozzle | | | |
| Production | IJ printing | Valve type | 0.15 | 0.21 | 1 |
| example 10 | | nozzle | | | |
| Production | Die coating + | | | | |
| example 11 | concave-convex | | | | |
| | mold press | | | | |
| Production | Die coating + | Valve type | 0.15 | 0.85 | 2 (Drying |
| example 12 | IJ printing | nozzle | | | each time) |
| Production | IJ printing | MH2810F | 0.02 | 0.85 | 10 (Drying |
| example 13 | (multi-coating) | | | | each time) |

### Examples 1 to 35 and Comparative Examples 1 to 4

Each electrode mixture layer forming liquid composition and each production example were combined as presented in Tables 3 and 4 to produce electrodes of Examples and Comparative examples. For the obtained electrodes, confirmation of the presence or absence of the electrode concave-convex periodic structure, measurement of the electrode concave-convex period, measurement of the concave-convex height, measurement of the volume density, evaluation of the peel strength, and evaluation of the rate characteristic were performed. The results are presented in Tables 3 and 4.

Note that, in a case where the roll press processing is performed, the concave-convex height after pressing is also measured. Further, the volume density is measured, and the peel strength and the rate characteristic are evaluated after pressing.

For the roll press processing, a 7t hydraulic roll press machine (manufactured by Thank Metal) was used. The film thickness that resulted in the volume density presented in Tables 3 and 4 was calculated backward, and this value was set as a gap for pressing.

### Confirmation of Presence or Absence of Periodic Concave-Convex Structure and Measurement of Period

Observation was performed using a laser microscope VK-X3000 (manufactured by Keyence Corp.) equipped with a white light interferometer to obtain a cross-sectional concave-convex profile perpendicular to the electrode transport direction and measure an average electrode concave-convex period.

The average period was calculated by selecting five consecutive points based on the apex of the convex portion in one period randomly selected near the center of the electrode in the obtained concave-convex profile, and multiplying an average value of the distance of each point by 2. The results are presented in Tables 3 and 4.

### Measurement of Concave-Convex Height

A height h1 of the concave portion and a height h2 of the convex portion were each calculated from the cross-sectional concave-convex profile obtained by measuring the period. The height hl of the concave portion and the height h2 of the convex portion were each calculated as an average value by selecting five consecutive points based on the minimum point and the maximum point, respectively, in the one period randomly selected in the obtained concave-convex profile. The results are presented in Tables 3 and 4.

### Measurement of Volume Density

Three electrodes were each punched out with a Φ16 mm punch, and the weight of the electrode including the substrate was measured. The average film thickness was calculated from the value obtained from the measurement of the concave-convex height. Three substrates were each punched out with the Φ16 mm punch to measure the weight of the substrate alone. The weight of the electrode excluding the substrate was calculated by subtracting the weight of the substrate. The volume density was calculated as follows: weight of electrode excluding substrate/(average film thickness×electrode surface area). The results are presented in Tables 3 and 4.

### Evaluation of Peel Strength

A KAPTON tape with a width of 10 mm and an adhesion length of 30 mm was attached to the electrode mixture layer, and a peel strength F (N/m) was measured using a benchtop tensile tester (EZ-SX 100N, manufactured by Shimadzu Corp.). The peel angle was 90° and the peel speed was 30 mm/min. The evaluation was performed three times under the same conditions, and the average value was calculated. The results are presented in Tables 3 and 4.

### Evaluation of Rate Characteristic

The rate characteristic evaluation of the positive electrode or the negative electrode was measured using a charge/discharge measuring device (TOSCAT3001, manufactured by Toyo System Co., Ltd.).

The electrode thus produced was punched into a round shape with a diameter of 16 mm, and then the resulting electrode, a 100 μm thick glass separator D (manufactured by Advantec), an electrolyte liquid (1.5 mol/L LiPF₆/(ethylene carbonate (EC):dimethyl carbonate (DMC):ethyl methyl carbonate (EMC) (1:1:1 v/v %)+fluoroethylene (FEC) 10%) (manufactured by Kishida Chemical Co., Ltd.)), and a 200 μm thick lithium foil (manufactured by Honjo Metal Co., Ltd.) as a counter electrode were placed in a coin can to produce an electrochemical element.

For evaluating the positive electrode, the electrochemical element thus produced was charged at a constant current at a C-rate of 0.2 C, 1.0 C, 2.0 C, 3.0 C, 4.0 C, or 5.0 C to 4.2 V at room temperature (25° C.), and then discharged at a constant current to 3.0 V to measure the charge/discharge capacity. Further, a ratio of the discharge capacity at 0.2 C and the discharge capacity at 5.0 C is defined as a capacity maintenance rate to evaluate the rate characteristic.

For evaluating the negative electrode, the rate characteristic was evaluated under the same conditions as the positive electrode, except that the electrochemical element was charged at a constant current to 2.0 V and discharged at a constant current to 0.05 V. Note that the C rate refers to a rate of charge and discharge, and in a case of the constant current charge/discharge measurement, 1.0 C is defined as a unit of current at which a theoretical capacity of battery is fully charged (or discharged) in one hour.

For comparison, an electrode having a flat positive electrode mixture layer or a flat negative electrode mixture layer was produced by applying the electrode mixture layer forming liquid composition having the same composition to the substrate using an applicator and drying the liquid composition. The rate characteristic of this electrode was set to 100 to calculate the capacity maintenance ratio. Note that the rate characteristic (capacity maintenance) ratio exceeding 110 was determined to be acceptable. Evaluation was performed three times under the same conditions, and the average value was calculated. The results are presented in Tables 3 and 4.

TABLE 3

| | Electrode | | | Electrode mixture layer | | | | | | | |
|---|---|---|---|---|---|---|---|---|---|---|---|
| | mixture | | | Electrode concave- | | | | | | | |
| | layer | | | convex periodic | | | | | | Evaluation | |
| | forming | | | structure | | h1/h2 | Pressing | h1/h2 | Volume | Peel | Capacity |
| | liquid | Production | | Presence/ | | (before | after | (after | density | strength | maintenance |
| | composition | example | Substrate | absence | Period | pressing) | drying | pressing) | [g/cm³] | ratio | ratio |
| Example 1 | Liquid | Production | Cu foil | Yes | 1.27 | 0.71 | No | | 1.10 | 100 | 120 |
| | composition 3 | example 1 | | | | | | | | | |
| Example 2 | Liquid | Production | Cu foil | Yes | 1.27 | 0.82 | No | | 1.10 | 100 | 120 |
| | composition 4 | example 1 | | | | | | | | | |
| Example 3 | Liquid | Production | Cu foil | Yes | 1.27 | 0.85 | No | | 1.10 | 100 | 120 |
| | composition 5 | example 1 | | | | | | | | | |
| Example 4 | Liquid | Production | Cu foil | Yes | 1.27 | 0.82 | No | | 1.10 | 100 | 120 |
| | composition 4 | example 2 | | | | | | | | | |
| Example 5 | Liquid | Production | Cu foil | Yes | 1.27 | 0.82 | No | | 1.10 | 100 | 120 |
| | composition 4 | example 3 | | | | | | | | | |
| Example 6 | Liquid | Production | Cu foil | Yes | 1.69 | 0.95 | No | | 1.10 | 100 | 115 |
| | composition 5 | example 5 | | | | | | | | | |
| Example 7 | Liquid | Production | Cu foil | Yes | 0.85 | 0.82 | No | | 1.10 | 100 | 120 |
| | composition 5 | example 6 | | | | | | | | | |
| Example 8 | Liquid | Production | Cu foil | Yes | 0.64 | 0.85 | No | | 1.10 | 100 | 120 |
| | composition 4 | example 7 | | | | | | | | | |
| Example 9 | Liquid | Production | Cu foil | Yes | 0.42 | 0.92 | No | | 1.10 | 100 | 120 |
| | composition 4 | example 8 | | | | | | | | | |
| Example 10 | Liquid | Production | Cu foil | YES | 0.28 | 0.95 | NO | | 1.10 | 100 | 115 |
| | composition 4 | example 9 | | | | | | | | | |
| Example 11 | Liquid | Production | Cu foil | Yes | 1.27 | 0.71 | Yes | 0.80 | 1.15 | 100 | 125 |
| | composition 4 | example 1 | | | | | | | | | |
| Example 12 | Liquid | Production | Cu foil | Yes | 1.27 | 0.71 | Yes | 0.86 | 1.22 | 100 | 130 |
| | composition 4 | example 1 | | | | | | | | | |
| Example 13 | Liquid | Production | Cu foil | Yes | 1.27 | 0.71 | Yes | 0.99 | 1.30 | 100 | 130 |
| | composition 4 | example 1 | | | | | | | | | |
| Example 14 | Liquid | Production | Cu foil | Yes | 1.27 | 0.75 | No | | 1.10 | 100 | 120 |
| | composition 8 | example 1 | | | | | | | | | |
| Example 15 | Liquid | Production | Cu foil | Yes | 1.27 | 0.75 | Yes | 0.88 | 1.30 | 100 | 130 |
| | composition 8 | example 1 | | | | | | | | | |
| Example 16 | Liquid | Production | Cu foil | Yes | 1.27 | 0.75 | No | | 1.10 | 100 | 120 |
| | composition 9 | example 1 | | | | | | | | | |
| Example 17 | Liquid | Production | Cu foil | Yes | 1.27 | 0.75 | Yes | 0.88 | 1.30 | 100 | 130 |
| | composition 9 | example 1 | | | | | | | | | |
| Example 18 | Liquid | Production | Cu foil | Yes | 1.27 | 0.71 | No | | 1.10 | 100 | 120 |
| | composition 10 | example 1 | | | | | | | | | |
| Example 19 | Liquid | Production | Cu foil | Yes | 1.27 | 0.71 | Yes | 0.85 | 1.30 | 100 | 130 |
| | composition 10 | example 1 | | | | | | | | | |
| Example 20 | Liquid | Production | Cu foil | Yes | 1.27 | 0.85 | No | | 1.10 | 100 | 120 |
| | composition 11 | example 1 | | | | | | | | | |

TABLE 4

| | Electrode | | | Electrode mixture layer | | | | | | | |
|---|---|---|---|---|---|---|---|---|---|---|---|
| | mixture | | | Electrode concave- | | | | | | | |
| | layer | | | convex periodic | | | | | | Evaluation | |
| | forming | | | structure | | h1/h2 | Pressing | h1/h2 | Volume | Peel | Capacity |
| | liquid | Production | | Presence/ | | before | after | (after | density | strength | maintenance |
| | composition | example | Substrate | absence | Period | pressing) | drying | pressing) | [g/cm³] | ratio | ratio |
| Example 21 | Liquid | Production | Cu foil | Yes | 1.27 | 0.85 | Yes | 0.95 | 1.30 | 100 | 130 |
| | composition 11 | example 1 | | | | | | | | | |
| Example 22 | Liquid | Production | AL foil | Yes | 1.27 | 0.71 | Yes | 0.88 | 3.10 | 100 | 120 |
| | composition 14 | example 1 | | | | | | | | | |
| Example 23 | Liquid | Production | AL foil | Yes | 1.27 | 0.82 | Yes | 0.92 | 3.10 | 100 | 120 |
| | composition 15 | example 1 | | | | | | | | | |
| Example 24 | Liquid | Production | AL foil | Yes | 1.27 | 0.85 | Yes | 0.95 | 3.10 | 100 | 120 |
| | composition 16 | example 1 | | | | | | | | | |
| Example 25 | Liquid | Production | AL foil | Yes | 1.27 | 0.82 | Yes | 0.92 | 3.10 | 100 | 120 |
| | composition 15 | example 2 | | | | | | | | | |
| Example 26 | Liquid | Production | AL foil | Yes | 1.27 | 0.82 | Yes | 0.92 | 3.10 | 100 | 120 |
| | composition 15 | example 3 | | | | | | | | | |
| Example 27 | Liquid | Production | AL foil | Yes | 1.69 | 0.95 | Yes | 1.00 | 3.10 | 100 | 115 |
| | composition 16 | example 5 | | | | | | | | | |
| Example 28 | Liquid | Production | AL foil | Yes | 0.85 | 0.82 | Yes | 0.92 | 3.10 | 100 | 120 |
| | composition 16 | example 6 | | | | | | | | | |
| Example 29 | Liquid | Production | AL foil | Yes | 0.64 | 0.85 | Yes | 0.95 | 3.10 | 100 | 120 |
| | composition 15 | example 7 | | | | | | | | | |
| Example 30 | Liquid | Production | AL foil | Yes | 0.42 | 0.92 | Yes | 0.99 | 3.10 | 100 | 120 |
| | composition 15 | example 8 | | | | | | | | | |
| Example 31 | Liquid | Production | AL foil | Yes | 0.28 | 0.95 | Yes | 1.00 | 3.10 | 100 | 115 |
| | composition 15 | example 9 | | | | | | | | | |
| Example 32 | Liquid | Production | AL foil | Yes | 1.60 | 0.87 | Yes | 0.96 | 3.10 | 100 | 112 |
| | composition 12 | example 6 | | | | | | | | | |
| Example 33 | Liquid | Production | AL foil | Yes | 1.69 | 0.97 | Yes | 1.00 | 3.10 | 100 | 110 |
| | composition 12 | example 5 | | | | | | | | | |
| Example 34 | Lower layer: | Production | Cu foil | Yes | 0.85 | 0.89 | No | | 1.10 | 60 | 110 |
| | liquid | example 12 | | | | | | | | | |
| | composition 1 | | | | | | | | | | |
| | Upper layer: | | | | | | | | | | |
| | liquid | | | | | | | | | | |
| | composition 7 | | | | | | | | | | |
| Example 35 | Liquid | Production | Cu foil | Yes | 0.85 | 0.89 | No | | 1.10 | 60 | 110 |
| | composition 7 | example 13 | | | | | | | | | |
| Comparative | Liquid | Production | AL foil | Yes | 0.21 | 0.97 | Yes | 1.00 | 3.10 | 100 | 100 |
| example 1 | composition 15 | example 10 | | | | | | | | | |
| Comparative | Liquid | Production | AL foil | Yes | 0.21 | 0.98 | Yes | 1.00 | 3.10 | 100 | 100 |
| example 2 | composition 12 | example 10 | | | | | | | | | |
| Comparative | Liquid | Production | AL foil | Yes | 2.54 | 0.69 | Yes | 1.00 | 3.10 | 100 | 100 |
| example 3 | composition 4 | example 4 | | | | | | | | | |
| Comparative | Liquid | Production | Cu foil | Yes | 1.27 | 1.00 | Yes | 0.85 | 1.10 | 80 | 105 |
| example 4 | composition 1 | example 11 | | | | | | | | | |

From the results of Tables 3 and 4, it is found that the electrode produced by the production method of the electrode including the electrode mixture layer having the periodic concave-convex structure on the surface, the method including the electrode mixture layer forming liquid composition application step of applying the electrode mixture layer forming liquid composition including the active material and the dispersion medium onto the substrate at an application period of 0.28 mm or more and 1.7 mm or less using the liquid ejection device including the plurality of nozzle holes arranged in parallel to the substrate surface, or the electrode including the substrate and the electrode mixture layer being provided on the substrate and having the periodic concave-convex structure on the surface, in which the ratio (h1/h2) of the height h1 (μm) of the concave portion of the electrode mixture layer relative to the height h2 (μm) of the convex portion of the electrode mixture layer is 0.71 or more and 0.95 or less, has the good rate characteristic and binding properties.

Further, it is found that the excellent rate characteristic can be obtained when the viscosity of the electrode mixture layer forming liquid composition is 20 mPa·s or more, particularly 40 mPa·s or more, from the viewpoint of facilitating the formation of the electrode concave-convex periodic structure. Although the reason is unclear, it is presumed that this is due to the fact that the flow due to thermal convection is appropriately prevented in the electrode mixture layer forming liquid composition drying step, and as a result, unevenness in the film thickness and composition are prevented.

Further, it is found that the particularly excellent rate characteristic and binding properties can be obtained when the viscosity of the electrode mixture layer forming liquid composition is 150 mPa·s or less, particularly 100 mPa·s or less, from the viewpoint of facilitating the coalescence. Although the reason is unclear, it is presumed that this is because the electrode mixture layer forming liquid compositions applied from each nozzle are coalesced and mixed homogeneously.

Further, it is found that the volume density is increased by further pressing the electrode having the electrode concave-convex periodic structure and converting the concave-convex structure on the electrode surface into the sparse-dense structure inside the electrode, resulting in obtaining the electrode with particularly excellent volume energy density.

Further, it is found that good battery characteristics can be obtained in the production method for forming the periodic concave-convex structure that performs multiple times of the electrode mixture layer forming liquid composition application step and the electrode mixture layer forming liquid composition drying step. However, it is found that the effect is limited as compared to the case where printing is performed in one pass. Further, the biding properties were poor. Although the reason is unclear, it is presumed that this is because the occurrence of interfaces inside the electrode due to multiple times of the application step decreases the film strength and inhibits the formation of electron/ion conductive paths.

From the results of Comparative examples 1 to 3, it is found that if the application period is outside the range of the present disclosure, or if the ratio (h1/h2) is outside the range of the present disclosure, good rate characteristics are not obtained. Although the reason is unclear, it is presumed that if the application period exceeds the upper limit, the interval at which a part in which the electron conduction path is dominant and a part in which the ion conduction path is dominant appear alternately in the electrode mixture layer becomes long, making it difficult to exhibit the balancing effect of the electron conduction path and the ion conduction path. Further, it is presumed that, if the application period falls below the lower limit, in the electrode mixture layer forming liquid composition application step, the adjacent electrode mixture layer forming liquid compositions are immediately coalesced, causing the ratio (h1/h2) to approach 1, that is, making it difficult to obtain the electrode concave-convex periodic structure.

From the results of Comparative example 4, it is found that good binding properties are obtained when the flat electrode is formed by the die coater and then pressed using a mold having a concave-convex structure to produce the electrode having the periodic concave-convex structure. Although the reason is unclear, it is presumed that, in contrast to the method for producing an electrode according to an embodiment of the present invention, the volume density (porosity) of the convex portion becomes large, causing a reduction in the film strength of the convex portion.

Aspects of the present invention include, for example, the following.

### Aspect 1

A method for producing an electrode including applying an electrode mixture layer forming liquid composition including an active material and a dispersion medium onto a substrate at an application period of 0.28 mm or more and 1.7 mm or less, using a liquid ejection device having a plurality of nozzle holes arranged in parallel to a surface of the substrate, to form an electrode mixture layer having a periodic concave-convex structure on its surface.

### Aspect 2

The method for producing an electrode according to the <Aspect 1>, in which the liquid ejection device is an inkjet device.

### Aspect 3

The method for producing an electrode according to the <Aspect 2>, in which the inkjet device is of a valve head type.

### Aspect 4

The method for producing an electrode according to any of the <Aspect 1> to <Aspect 3>, in which the electrode mixture layer forming liquid composition has a viscosity of 20 mPa·s or more and 150 mPa·s or less.

### Aspect 5

An electrode produced by the method according to any of the <Aspect 1> to <Aspect 4>.

### Aspect 6

The electrode according to the <Aspect 5>, including:
the substrate; and
the electrode mixture layer on the substrate and having a periodic concave-convex structure on its surface,
in which a ratio (h1/h2) of a height h1 (μm) of a concave portion of the electrode mixture layer relative to a height h2 (μm) of a convex portion of the electrode mixture layer is 0.71 or more and 0.95 or less.

### Aspect 7

The electrode according to the <Aspect 5> or <Aspect 6>, in which the method further includes pressing the electrode.

The method for producing an electrode according to any of the <Aspect 1> to <Aspect 4> and the electrode according to any of the <Aspect 5> to <Aspect 7> can solve various conventional problems and achieve an object of the present invention.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A method for producing an electrode, the method comprising:
applying an electrode mixture layer forming liquid composition including an active material and a dispersion medium onto a substrate at an application period of 0.28 mm or more and 1.7 mm or less, using a liquid ejection device having a plurality of nozzle holes arranged in parallel to a surface of the substrate, to form an electrode mixture layer having a periodic concave-convex structure on its surface.

2. The method for producing the electrode according to claim 1, wherein the liquid ejection device is an inkjet device.

3. The method for producing the electrode according to claim 2, wherein the inkjet device is of a valve head type.

4. The method for producing the electrode according to claim 1, wherein the electrode mixture layer forming liquid composition has a viscosity of 20 mPa·s or more and 150 mPa·s or less.

5. An electrode produced by the method according to claim 1.

6. The electrode according to claim 5, wherein the electrode comprises:
the substrate; and
the electrode mixture layer on the substrate and having a periodic concave-convex structure on its surface,
wherein a ratio (h1/h2) of a height h1 (μm) of a concave portion of the electrode mixture layer relative to a height h2 (μm) of a convex portion of the electrode mixture layer is 0.71 or more and 0.95 or less.

7. The electrode according to claim 6, wherein the method further includes pressing the electrode.
